(19) United States
(12) Patent Application Publication
(10) Pub. No.: US 2006/0039160 A1
(43) Pub. Date: Feb. 23, 2006

(54) Lighting systems for producing different beam patterns

(76) Inventors: William J. Cassarly, Mason, OH (US); Thomas A. Hough, Tucson, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/210,275

(22) Filed: Aug. 23, 2005

Related U.S. Application Data
(60) Provisional application No. 60/603,602, filed on Aug. 23, 2004.

(51) Int. Cl. G02B 6/00

(52) U.S. Cl. 362/551

(57) ABSTRACT

Various embodiments described herein include lighting systems that produce an optical beam. Moreover, in various embodiments, the beam may be altered to provide, for example, a narrow beam or a wide beam. One such lighting system includes a light source, a diffusing optical element, and a projection lens. The diffusing optical element is disposed between the light source and the projection lens and can be translated to provide zoom capability.

### PRIORITY APPLICATIONS

This application claims the benefit of priority under 35 U.S.C. 119(e) to U.S. Provisional Patent Application No. 60/603,602, filed Aug. 23, 2004 and entitled “Adjustable Beam Expander” (Attorney Docket OPTRES.043PR), which is incorporated herein by reference in its entirety.

### BACKGROUND

1. Field of the Invention

The present teachings relate to lighting systems that can be adjusted to provide different beam patterns. Such lighting systems may be used, for example, for flashlights and other portable lights, bike light, automobile lights, surgical lights, stage lighting, studio lighting, display case lighting, down lights, track lighting, architectural lights, and other applications.

2. Description of the Related Art

An illumination source can distribute light over a spatial area. The distribution of the light over this range of spatial positions may be referred to as a beam pattern and more particularly, a spatial beam pattern. Similarly, an illumination source can distribute light over a range of angles. The distribution of light over a range of angles is referred to as an angular beam pattern.

Different lighting applications often require illumination sources that produce specific beam patterns. Illumination sources with adjustable beam patterns can be difficult to create without introducing complexity or reducing performance. Consequently, a variety of different illumination sources, each of which produces a different beam pattern, are marketed. Users often purchase and utilize a number of these different illumination sources to satisfy their specific requirements. In some cases, users install a single illumination source and switch out one or more optical elements, such as a cover plate, to produce a different beam pattern. However, switching out optical elements may be technically challenging, costly, and time consuming. Some applications require real time changes in a beam pattern. To satisfy this requirement, users often implement multiple illumination sources each of which produces a different beam pattern and switch between the illumination sources in real time. Using multiple illumination sources can be both expensive to implement and difficult to manage.

Accordingly, there is a need for a simple illumination source that produces an adjustable beam pattern and that is not difficult to implement or costly, and that does not degrade performance.

### SUMMARY

One embodiment of the invention comprises a lighting system for providing lighting. The lighting system is configured to produce a variable beam pattern. The lighting system comprises a light source, a diffusing optical element, and projection optics. The diffusing optical element is disposed in an optical path between the light source and the projection optics. The projection optics projects a beam having the beam pattern. The diffusing optical element is movable along the optical path thereby altering the beam pattern.

Another embodiment of the invention comprises a lighting system for providing lighting. The lighting system is configured to produce a beam pattern. The lighting system comprises a light source, a collector, projection optics and a diffusing optical element. The projection optics is disposed with respect to the light source to substantially concentrate light at a focus. The projection optics is configured to project a beam having the beam pattern. The diffusing optical element is disposed in an optical path between the light source and the projection optics at a distance from the focus.

Another embodiment of the invention comprises a lighting system for providing lighting. The lighting system is configured to produce a beam pattern. The lighting system comprises a light source, a diffusing optical element, and projection optics. The diffusing optical element is disposed in an optical path between the light source and the projection optics. The projection optics is configured to project a beam having the beam pattern. The projection optics is fixed with respect to the light source.

Another embodiment of the invention comprises a lighting system for providing lighting. The lighting system is configured to produce a beam pattern. The lighting system comprises a light source, a diffusing optical element configured to distribute light into a range of angles, and projection optics. The diffusing optical element is disposed in an optical path between the light source and the projection optics. The projection optics is configured to project a beam having the beam pattern. The diffusing optical element has a profile that determines the range of angles into which light is distributed at different locations across the diffusing optical element. The profile is configured such that the range of angles is different for different locations on the diffusing optical element.

Another embodiment of the invention comprises a lighting system for providing lighting. The lighting system is configured to produce a beam pattern. The lighting system comprises a light source; an optical element having an optical aperture therein, and projection optics. The optical element has an optical property that is absent in the aperture. The projection optics is configured to project a beam having the beam pattern. The optical element is disposed in an optical path between the light source and the projection optics.

Another embodiment of the invention comprises a lighting system for providing lighting. The lighting system is configured to produce a beam pattern. The lighting system comprises a light source, a diffusing optical element, projection optics, and a mask. The projection optics is configured to project a beam having the beam pattern. The diffusing optical element is disposed in an optical path between the light source and the projection optics. A mask is disposed in the optical path between the diffusing optical element and the light source.

Another embodiment of the invention comprises a lighting system for providing lighting. The lighting system is configured to produce a beam pattern. The lighting system comprises a light source, a diffusing optical element, and projection optics. The projection optics is configured to project a beam having the beam pattern. The diffusing optical element is disposed in an optical path between the light source and the projection optics. The projection optics is diffusing.

Another embodiment of the invention comprises a lighting system for providing lighting. The lighting system is configured to produce a beam pattern. The lighting system comprises: a light source, a first diffusing optical element, projection optics, and a second diffusing optical element. The projection optics is configured to project a beam having the beam pattern. The first diffusing optical element is disposed in an optical path between the light source and the projection optics. The projection optics is between the first and second diffusing optical elements.

Another embodiment of the invention comprises a lighting system for providing lighting. The lighting system is configured to produce a variable beam pattern. The lighting system comprises a light source, projection optics, and a variable diffusing optical element. The projection optics is configured to project a beam having the beam pattern. The light source and the projection optics forms an optical path. The variable diffusing optical element is disposed in the optical path. The variable diffusing optical element is configured to distribute light into a range of directions defined by an angular spread, the variable diffusing optical element is adjustable to vary the angular spread to alter the beam pattern.

Another embodiment of the invention comprises a method of manufacturing a lighting system for providing lighting. The lighting system is configured to produce a variable beam pattern. The method comprises: providing a light source; positioning projection optics with respect to the light source to form an optical path therebetween, said projection optics configured to project a beam having said beam pattern; and disposing a diffusing optical element along said optical path, said diffusing optical element configured to move along said optical path to thereby alter said beam pattern.

Another embodiment of the invention comprises a method of manufacturing a lighting system for providing lighting. The lighting system is configured to produce a beam pattern. The method comprises: providing a light source; disposing a collector with respect to said light source to substantially focus light at a focus; positioning projection optics so as to form an optical path between said light source and said projection optics, said projection optics configured to project a beam having said beam pattern; and disposing a diffusing optical element in said optical path at a distance from said focus.

Another embodiment of the invention comprises a method of manufacturing a lighting system for providing lighting. The lighting system is configured to produce a beam pattern. The method comprises: providing a light source; positioning projection optics so as to form an optical path between said light source and said projection optics, said projection optics configured to project a beam having said beam pattern; and disposing a diffusing optical element in said optical path, wherein said projection optics is fixed in location with respect to said light source.

Another embodiment of the invention comprises a method of manufacturing a lighting system for providing lighting. The lighting system is configured to produce a beam pattern. The method comprises: providing a light source; positioning projection optics so as to form an optical path between said light source and said projection optics, said projection optics configured to project a beam having said beam pattern; disposing a diffusing optical element in said optical path, said diffusing optical element configured to distribute light into a range of angles, wherein the diffusing optical element has a profile that determines the range of angles into which light is distributed at different locations across said diffusing optical element, said profile being configured such that the range of angles is different for different locations on said diffusing optical element.

Another embodiment of the invention comprises a method for manufacturing a lighting system for providing lighting. The lighting system is configured to produce a beam pattern. The method comprises: providing a light source; positioning projection optics so as to form an optical path between the light source and the projection optics, said projection optics configured to project a beam having said beam pattern; and disposing an optical element having an optical aperture therein in said optical path, said optical element having an optical property that is absent in said aperture.

Another embodiment of the invention comprises a method of manufacturing a lighting system for providing lighting. The lighting system is configured to produce a beam pattern. The method comprises: providing a light source; positioning projection optics with respect to said light source to form an optical path therebetween, said projection optics configured to project a beam having said beam pattern; disposing a diffusing optical element in said optical path; and disposing a mask in the optical path between said diffusing optical element and said light source.

Another embodiment of the invention comprises a method of manufacturing a lighting system for providing lighting. The lighting system is configured to produce a beam pattern. The method comprises: providing a light source; positioning diffusing projection optics to form an optical path between said light source and said projection optics, said projection optics configured to project a beam having said beam pattern; and disposing a diffusing optical element in said optical path.

Another embodiment of the invention comprises a method of manufacturing a lighting system for providing lighting. The lighting system is configured to produce a beam pattern. The method comprises: providing a light source; positioning projection optics to form an optical path between said light source and said projection optics, said projection optics configured to project a beam having said beam pattern; disposing a first diffusing optical element in said optical path; and disposing a second diffusing optical element such that said projection optics is between said first and second diffusing optical elements.

Another embodiment of the invention comprises a method of manufacturing a lighting system for providing lighting. The lighting system is configured to produce a variable beam pattern. The method comprises: providing a light source; positioning projection optics such that said light source and said projection optics form an optical path, said projection optics configured to project a beam having said beam pattern; and disposing a variable diffusing optical element in said optical path, said variable diffusing optical element configured to distribute light into a range of directions defined by an angular spread, said variable diffusing optical element adjustable to vary said angular spread to alter said beam pattern.

Another embodiment of the invention comprises a lighting system for providing lighting. The lighting system is configured to produce a variable beam pattern. The lighting system comprises: means for producing light, means for projecting a beam having said beam pattern, and means for diffusing light. The light producing means and the beam projecting means define an optical path therebetween. The light diffusing means is disposed in the optical path. The light diffusing means is movable along the optical path to thereby alter the beam pattern.

Another embodiment of the invention comprises a lighting system for providing lighting. The lighting system is configured to produce a beam pattern. The lighting system comprises: means for producing light, means for collecting light, means for projecting a beam having said beam pattern, and means for diffusing light. The light collecting means is disposed with respect to the light producing means to substantially concentrate light at a focus. The light collecting means and the beam projecting means define an optical path therebetween. The light diffusing means is disposed in the optical path at a distance from the focus.

Another embodiment of the invention comprises a lighting system for providing lighting. The lighting system is configured to produce a beam pattern. The lighting system comprises: means for producing light, means for projecting a beam having said beam pattern, and means for diffusing light. The light producing means and the beam projecting means define an optical path therebetween. The light diffusing means is disposed in the optical path. The beam projecting means is fixed with respect to the light producing means.

Another embodiment of the invention comprises a lighting system for providing lighting. The lighting system is configured to produce a beam pattern. The lighting system comprises: means for producing light, means for projecting a beam having the beam pattern, and means for diffusing light and distributing the light into a range of angles. The light producing means and the beam projecting means define an optical path therebetween. The light diffusing means has a profile that determines the range of angles. The light diffusing means is disposed in the optical path.

Another embodiment of the invention comprises a lighting system for providing lighting. The lighting system is configured to produce a beam pattern. The lighting system comprise: means for producing light, means for projecting a beam having said beam pattern, means for diffusing light, and means for masking. The light producing means and the beam projecting means define an optical path therebetween. The light diffusing means is disposed in the optical path. The masking means is disposed in the optical path between the light producing means and the light diffusing means.

Another embodiment of the invention comprises a lighting system for providing lighting. The lighting system is configured to produce a beam pattern. The lighting system comprises: means for producing light, means for projecting a beam having said beam pattern, and means for diffusing light. The light producing means and the beam projecting means define an optical path therebetween. The light diffusing means is disposed in the optical path. The beam projecting means is diffusing.

Another embodiment of the invention comprises a lighting system for providing lighting. The lighting system is configured to produce a beam pattern. The lighting system comprises: means for producing light, means for projecting a beam having said beam pattern, and first and second means for diffusing light. The light producing means and the beam projecting means define an optical path therebetween. The first and second light diffusing means are disposed in the optical path. The beam projecting means is disposed between the first and second light diffusing means.

Another embodiment of the invention comprises a lighting system for providing lighting. The lighting system is configured to produce a variable beam pattern. The lighting system comprises: means for producing light, means for projecting a beam having said beam pattern, and means for diffusing light through a range of angles. The light producing means and the beam projecting means define an optical path therebetween. The light diffusing means is disposed in the optical path between the light producing means and the beam projecting means. The light diffusing means is variable such that the range of angles can be varied.

Another embodiment of the invention comprises a method of providing lighting having a variable beam pattern. The method comprises producing light, propagating the light through a diffusing optical element and projection optics to form a beam having a beam pattern. The method further comprises translating the diffusing optical element to vary the size of the beam pattern.

Another embodiment of the invention comprises a method of providing lighting having a beam pattern. The method comprises producing light, collecting the light, concentrating the light into a region, and propagating the light through a diffusing optical element and projection optics to form a beam having a beam pattern. The method further comprises disposing the diffusing optical element a distance from the region where the light is concentrated.

Another embodiment of the invention comprises a method of providing lighting having a beam pattern. The method comprises producing light from a light source, and propagating the light through a diffusing optical element and projection optics to form a beam having a beam pattern. The projection optics is fixed with respect to the light source.

Another embodiment of the invention comprises a method of providing lighting having a beam pattern. The method comprises producing light and propagating the light through a diffusing optical element to distribute the light into a range of angles. The method further comprises propagating the light through projection optics to form a beam having a beam pattern. The light diffusing means has a profile that determines the range of angles.

Another embodiment of the invention comprises a method of providing lighting having a beam pattern. The method comprises producing light and propagating the light through a mask, a diffusing optical element, and projection optics to form a beam having a beam pattern.

Another embodiment of the invention comprises a method of providing lighting having a beam pattern. The method comprises producing light and propagating the light through a diffusing optical element and diffusing projection optics to form a beam having a beam pattern.

Another embodiment of the invention comprises a method of providing lighting having a beam pattern. The method comprises producing light and propagating the light through an optical element having an optical aperture therein, the optical element having an optical property that is absent in the aperture. The method further comprises propagating the light through projection optics after being propagated through the optical element so as to form a beam having a beam pattern.

Another embodiment of the invention comprises a method of providing lighting having a beam pattern. The method comprises producing light and propagating the light through a diffusing optical element and projection optics to form a beam having a beam pattern. The method further comprises diffusing the light more after the light has propagated though the projection optics.

Another embodiment of the invention comprises a method of providing lighting having a beam pattern. The method comprises producing light and propagating the light through a diffusing optical element and projection optics to form a beam having a beam pattern. The diffusing optical element is variable such that the range of angles into which light is diffused and distributed can be varied.

In other embodiments of the invention, the lighting systems, such as described above, comprise a flashlight, a bike light, an automobile light (e.g. a headlight), a stage light, a studio light, a surgical light, a display case light, a down light, a light for track lighting, a light for architectural lighting, or other devices for providing light. In certain embodiments of the invention, the lighting systems, such as described above, further comprise a housing, and/or assembly, frame, or support structure to form the flashlight, bike light, automobile light (e.g., headlight), stage light, studio light, a surgical light, display case light, down light, light for track lighting, light for architectural lighting, or other devices for providing light. In certain embodiments of the invention, the light source, the diffusing optical element, and the projection optics may be combined with such housing and/or assembly, frame, or support structure to form the flashlight, bike light, automobile light (e.g., headlight), stage light, studio light, surgical light, display case light, down light, light for track lighting, light for architectural lighting, or other devices for providing light. In some embodiments of the invention, the lighting systems, such as described above, may include an electrical power connector, contact, or connection configured to receive power such as electrical power from, e.g., a battery or electrical power line, to power the light source. In some embodiments of the invention, the lighting systems, such as described above, may also include one or more connectors for attachment to mounts, tracks, stands, or supports such as for a stage light, a studio light, a display case light, a down light, a light for track lighting, a light for architectural lighting, or other devices for providing light. In some embodiments of the invention, the lighting systems, such as described above, may also include the mounts, tracks, stands, or supports such as for a stage light, a studio light, a surgical light, a display case light, a down light, a light for track lighting, a light for architectural lighting, or other devices for providing light. In some embodiments of the invention, the light source, diffuser, and projection lens may be included in a module that can be attached to an assembly, a housing or portion thereof, a mount, track, stand, or support, to form, for example, a flashlight, a bike light, an automobile light (e.g., a headlight), a stage light, a studio light, a surgical light, a display case light, a down light, a light for track lighting, a light for architectural lighting, or other devices for providing light. A secure attachment may be provided by, for example, by snap fit, threading, welding, riveting, and may be glued, screwed together, bolted, fastened, latched, or otherwise securely connected. In certain embodiments, where the module includes a solid state light source, the module is referred to herein as a solid state emitter module. In certain embodiments of the invention, the lighting systems, such as described above, are configured to produce an output of at least about 10,000 nits, 100,000 nits, or 1,000,000 nits. Other configurations, designs, methods, and applications are also possible.

### BRIEF DESCRIPTION OF THE DRAWINGS

FIG. 1A schematically illustrates a lighting system comprising a projection lens disposed in front of a light source.

FIG. 1B is a plot of illuminance versus position for a beam pattern comprising a localized “spot” (referred to as the spot beam pattern) that is produced by the lighting system shown in FIG. 1A.

FIG. 2A schematically illustrates a lighting system with a diffuser disposed between the light source and the projection lens proximal to the source.

FIG. 2B is a plot of illuminance versus position for a beam pattern produced by the lighting system configuration shown in FIG. 2A.

FIG. 3A schematically depicts the lighting system wherein the diffuser is proximal to the projection lens.

FIG. 3B is a plot of illuminance versus position for an enlarged beam pattern (referred to as the “flood beam pattern”) that is produced by the configuration shown in FIG. 3A.

FIG. 4A schematically illustrates a lighting system comprising a translatable diffuser disposed between a light source and a projection lens showing rays of light traced through the lighting system.

FIG. 4B is a plot of illuminance versus position for a “spot” beam pattern produced with the diffuser proximal to source.

FIG. 4C is a plot of illuminance versus position for a “flood” beam pattern produced with the diffuser proximal to the lens.

FIG. 5A schematically illustrates a lighting system comprising an emitter, a collector, a diffuser, and a projection lens, wherein the emitter is disposed in the collector and the diffuser is proximal to the collector.

FIG. 5B is a plot of intensity versus angle for a beam pattern that is produced by the configuration shown in FIG. 5A using a diffuser having a 6 degree angular spread (6° diffuser).

FIG. 5C is a plot of intensity versus angle for a beam pattern produced by the configuration shown in FIG. 5A using a diffuser having a 12 degree angular spread (12° diffuser).

FIG. 6A schematically depicts the lighting system with the diffuser centered between the collector and the projection lens.

FIGS. 6B and 6C are plots of intensity versus angle for beam patterns produced by the configuration shown in FIG. 6A using 6° and 12° diffusers, respectively.

FIG. 7A schematically illustrates the lighting system with the diffuser proximal to the projection lens.

FIGS. 7B and 7C are plots of intensity versus angle for beam patterns produced by the configuration shown in FIG. 7A using 6° and 12° diffusers, respectively.

FIG. 8A schematically illustrates a lighting system having the same configuration as shown in FIG. 5A, wherein the diffuser is proximal to the collector.

FIGS. 8B-8F are plots of intensity versus angle for beam patterns produced by the lighting system shown in FIG. 8A for diffuser angular spreads of 0°, 3°, 6°, 9°, and 12°, respectively.

FIG. 9A schematically illustrates a lighting system having the same configuration as shown in FIG. 7A wherein the diffuser is proximal to the projection lens.

FIGS. 9B-9F are plots of intensity versus angle for beam patterns produced by the configuration shown in FIG. 9A with diffuser angular spreads of 0°, 3°, 6°, 9°, and 12°, respectively.

FIG. 10A is a plot of efficiency versus diffuser angular spread for a configuration such as shown in FIG. 5A wherein the diffuser is proximal the collector.

FIG. 10B is a plot of efficiency versus diffuser angular spread for a configuration such as shown in FIG. 6A wherein the diffuser is about midway between the collector and the projection lens.

FIG. 10C is a plot of efficiency versus diffuser angular spread for a configuration such as shown in FIG. 7A wherein the diffuser is proximal the projection lens.

FIG. 11 schematically illustrates a lighting system with a diffuser configured to provide an angular spread in a central circular region that that is different than the angular spread provided in a surrounding annular region.

FIG. 12 schematically illustrates a lighting system comprising an emitter, collector, diffuser, and projection lens, wherein the diffuser has a hole centrally located therein.

FIG. 13A is a plot of intensity versus angle for a beam produced by a lighting system similar to that shown in FIG. 12 in “spot mode” wherein the diffuser is proximal to the collector.

FIG. 13B is a plot of intensity versus angle for a beam produced by a lighting system similar to that shown in FIG. 12 in “flood mode” with the diffuser proximal to the projection lens.

FIG. 13C is a plot of intensity versus angle for a beam produced by a lighting system similar to that shown in FIG. 12 in “flood mode” but having a diffuser applied to a central portion of the projection lens.

FIG. 14A schematically illustrates a lighting system comprising a mask proximal to a collector and a diffuser located about midway between the collector and a projection lens.

FIG. 14B is a plot of intensity versus angle for a beam that is produced by the lighting system such as shown in FIG. 14A with the diffuser located proximal to the collector.

FIG. 14C is a plot of intensity versus angle for a beam is produced by the lighting system such as shown in FIG. 14A with the diffuser located proximal to the projection lens.

FIG. 15 schematically illustrates a lighting system using a fiber optic source according to another embodiment of the invention.

FIG. 16 schematically illustrates a lighting system using an LED as the source according to another embodiment of the invention.

FIG. 17 schematically illustrates a lighting system comprising a light source, a collector, a diffusing optical element and a projection lens, wherein the diffusing optical element comprises a diffuser and a lens.

FIG. 18 schematically illustrates a lighting system comprising a pin that can be used to translate the diffusing optical element.

FIG. 19 schematically illustrates a lighting system comprising a pair of magnets that can be used to translate the diffusing optical element.

FIGS. 20A and 20B schematically illustrates a diffusing optical element comprising a flexible membrane.

### DETAILED DESCRIPTION OF THE PREFERRED EMBODIMENT

Certain embodiments of the invention include lighting systems or assemblies that produce an optical beam. Moreover, in various embodiments, the beam may be altered to provide, for example, a narrow beam or a wide beam.

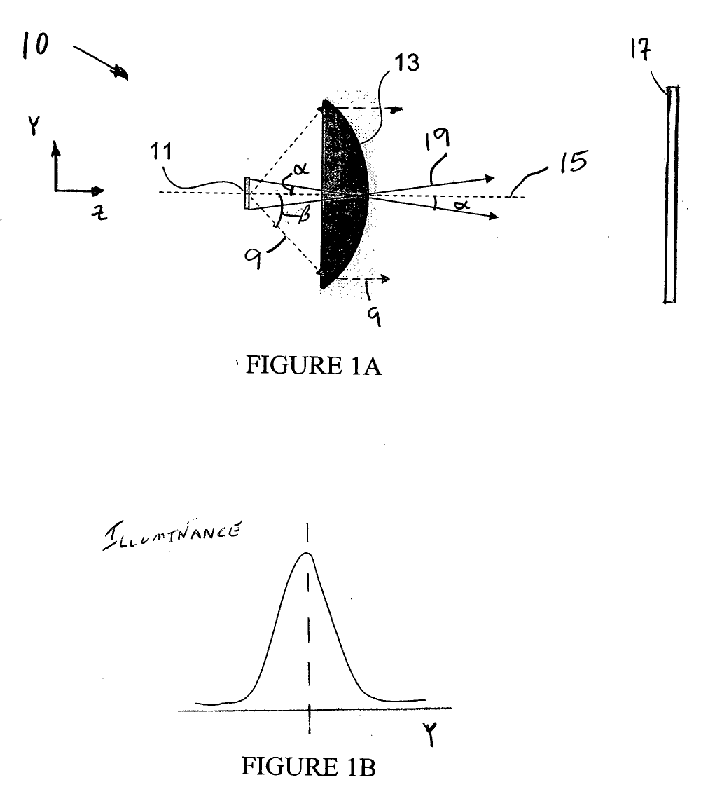

FIG. 1A schematically illustrates a lighting system 10 comprising a light source 11 and a projection lens 13 aligned along an optical axis 15. The light source 11 is shown as an extended source having finite lateral dimensions. This light source 11 may comprise, for example, an incandescent bulb or a light emitting diode (LED).

The projection lens 13 comprises a lens having optical power and a corresponding focal length. The light source 11 and the projection lens 13 are positioned with respect to each other such that the light source is imaged by the projection lens. Light in the form of a beam propagates along an optical path from the light source 11 through the projection lens 13. The beam continues along the optical path, which in FIG. 1A is centered about the optical axis 15.

This light beam may be directed onto a surface 17 such as the surface of a screen or an object as shown in FIG. 1A. A beam pattern, which is determined by the distribution of light within the beam, may thereby be formed on this surface 17. This beam pattern may have a shape, size, and brightness distribution that depends on the lighting system 10. In some embodiments, for example, this beam pattern may be substantially circular and may have a Gaussian intensity distribution centered about the optical axis 15. In this embodiment, the size of the beam pattern depends on the size of the light source 11 and the distance from the light source to the projection lens 13 (object distance).

Chief rays 19 (solid arrows) shown in FIG. 1A extend from edges of the light source 11 through the center (or nodal points) of the projection lens 13, where the optical axis 15 passes through the projection lens, and continue along the optical path. The chief rays 19 show how the beam propagates to the surface 17, which is illuminated by the lighting system 10. The chief rays 19 also illustrate how the size of the light source 11 and size of the beam pattern are related. The chief rays 19 subtend an angle α as measured with respect to the optical axis 15 on both sides of the projection lens 13. The angular subtense of the object, here the light source 11, determines the angular subtense of the image and, thus, the size of the beam and the beam pattern in the far field of the lens 13.

Similarly, the size of the light source 11 as well as the position of the projection lens 13 with respect to the light source affects the rough size of the beam pattern.

Marginal rays 9 (dashed arrows) extend from the center of the light source 11, where the light source intersects the optical axis 15 to the edges of the projection lens 13. The marginal rays 9 are indicative of the range of angles (0° through β) through which light is emitted from the light source 11 and collected by the projection lens 13. In various preferred embodiments, the angular distribution β of light collected by the projection lens 13 is typically large compared to the angular width α of the beam pattern.

FIG. 1B is a plot of illuminance versus position (y) for a beam produced by the lighting system 10 depicted in FIG. 1A. The illuminance is plotted for positions on the surface 17 of the screen along a direction parallel to the Y axis and through the optical axis 15 (Z). Accordingly, this plot of illuminance versus position is representative of the spatial beam pattern, or spatial distribution of light within the beam. The plot comprises a peak centered about the optical axis 15. As described above, the beam produced by the lighting system 10 of FIG. 1A may be circularly symmetric and may have a spatial beam pattern that comprises a circularly symmetric distribution with a peak centered on the optical axis 15.

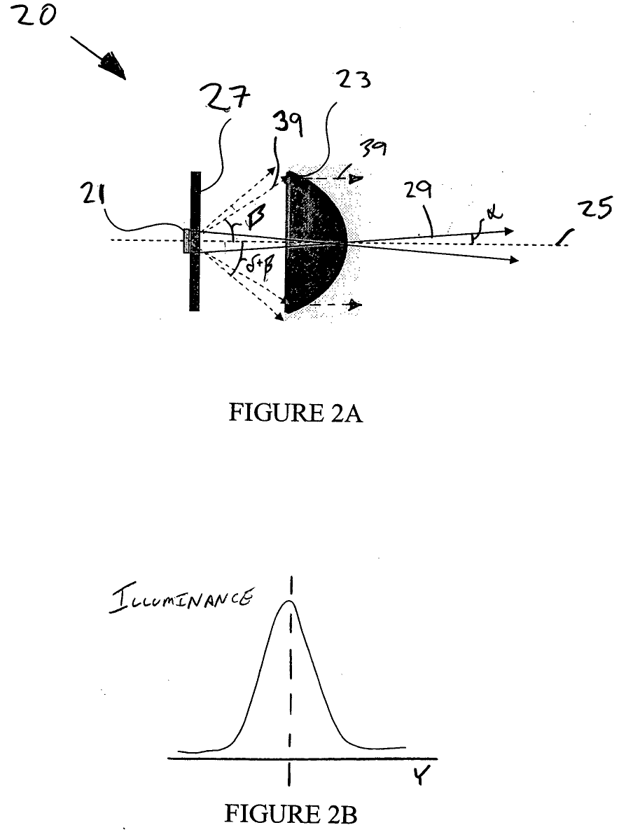

As shown in FIG. 2A, in other embodiments, a lighting system 20 may include a light source 21 and a projection lens 23 aligned along an optical axis 25 such as discussed above. However, the lighting system 20 may further comprise a diffuser 27 disposed between the light source 21 and the projection lens 23. Light from the light source 21 propagates through the diffuser 27 and the projection lens 23. The light forms an optical beam that continues along the optical path away from the projection lens 23. This beam may be centered about the optical axis 25.

Chief rays 29 extend from the edges of the light source 21, through the center (or nodal points) of the projection lens 23, and onward. The chief rays 29, at an angle, α, with respect to the optical axis 25 are indicative of the size of the beam away from the lens 23. Marginal rays 39 extending from the center of the light source 21 to the edges of the projection lens 23 show the range of angles (0° through β) through which light emitted by the light source 11 is collected by the projection lens 23.

The diffuser 27 may scatter collimated light into a range of angles, δ, referred to herein as the angular spread of the diffuser. In the configuration shown in FIG. 2A, such a diffuser 27 scatters light from the source 21 into a range of angles, δ+β, referred to herein as the angular spread of the diffused source. The angular spread of the diffused source, δ+β, may be determined by the diffuser 27. In certain embodiments, such as shown in FIG. 2A, the angular spread of the diffuser, δ, is small compared to the collection angle β of the projection lens 23.

The diffuser 27 can be inserted proximal to the light source 21 without significantly altering the beam. In particular, the amount of flux in the beam pattern is substantially the same for the case with the diffuser 27 proximal to the light source 23 and the case with the diffuser removed. Similarly, the width of the beam pattern is substantially the same for the case with the diffuser 27 proximal to the light source 23 as the case with the diffuser removed.

FIG. 2B is a plot of illuminance versus position (y) for a beam produced by the lighting system 20 depicted in FIG. 2A with the diffuser 27 proximal to the light source 21. This plot of illuminance versus position is representative of the spatial beam pattern, or spatial distribution of light within the beam. The plot comprises a peak centered about the optical axis 25. The beam produced by the lighting system 20 of FIG. 2A may be circularly symmetric and may have a spatial beam pattern that comprises a circularly symmetric distribution with a peak centered on the optical axis 25.

The plots in FIGS. 1B and 2B are substantially similar. The insertion of the diffuser 27 proximal to the light source 21 does not substantially alter the spatial beam pattern.

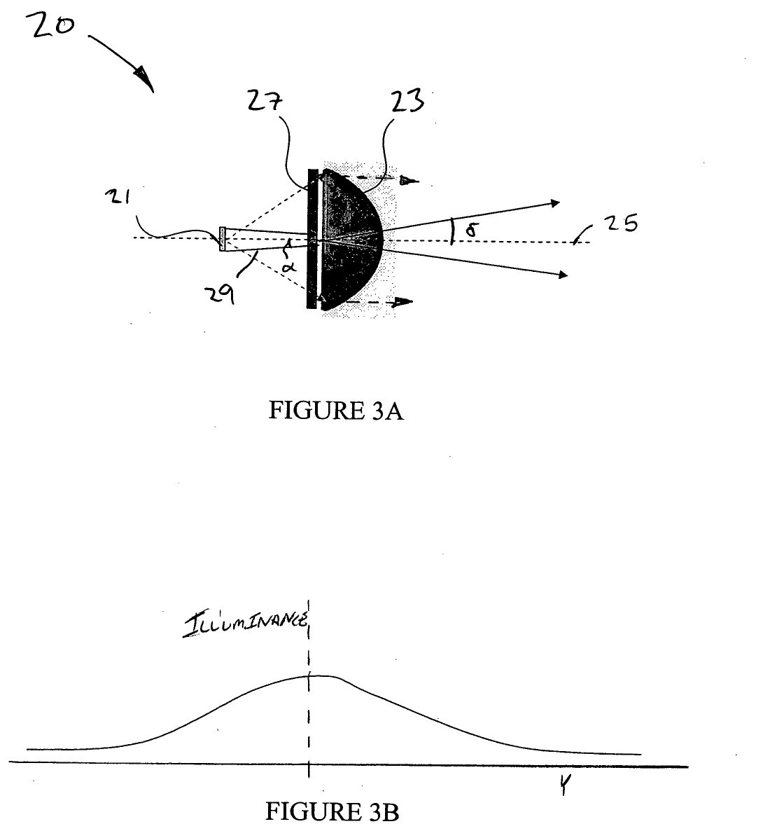

FIG. 3A shows the lighting system 20 with the diffuser 27 proximal to the projection lens 23. The result is that the beam pattern is substantially enlarged. To illustrate this effect, FIG. 3A shows the chief rays 29 converging onto the center of the projection lens 23. As discussed above, without the diffuser, the chief rays 29 subtend an angle α as measured with respect to the optical axis 25 on both sides of the projection lens 23. Accordingly, the image of the light source 11 without the diffuser has an angular subtense of α. Similarly, the beam pattern will have an angular substense of α away from the lens 23.

In contrast, with the diffuser 27 proximal to the projection lens 23, light incident on the projection lens appears to come from a source that is larger than the case of no diffuser. In certain embodiments, such as shown in FIG. 3A, the angular spread, δ, of the diffuser 27 is substantially larger than the angle α subtended by the chief ray 27. Accordingly, the angular subtense of the beam pattern will be enlarged. A first order approximation is that the beam pattern produced by the lighting system 20 is the convolution of the beam pattern resulting from the light source 21 and projection lens 23 with no diffuser 27 and the beam pattern for collimated light passing through the diffuser. When δ is large compared to α, the angular subtense of the beam will correspond to the angular spread, δ. Using convolution to compute beam pattern is described in W. J. Cassarly and A. P. Riser, “Analysis of Single Lens Arrays Using Convolution,” Optical Engineering, Vol. 40, No. 5, pp. 805-813, 2001.

FIG. 3B is a plot of illuminance versus position (y) for a beam produced by the lighting system 20 depicted in FIG. 3A with the diffuser 27 proximal to the projection lens 23. This plot of illuminance versus position is representative of the spatial beam pattern, or spatial distribution of light within the beam. The plot comprises a peak centered about the optical axis 25. This peak is substantially wider than the peak shown in FIG. 2B wherein the diffuser 27 is proximal to the light source 21.

Thus, if the diffuser 27 is disposed at the light source 11, the spatial dimensions of the beam is relatively narrow. Conversely, if the diffuser 27 is moved closer to the projection lens 23, the size of the beam pattern is relatively wide. The collection efficiency of the projection lens 23, however, remains high even with the diffuser 27 close to the projection lens 23.

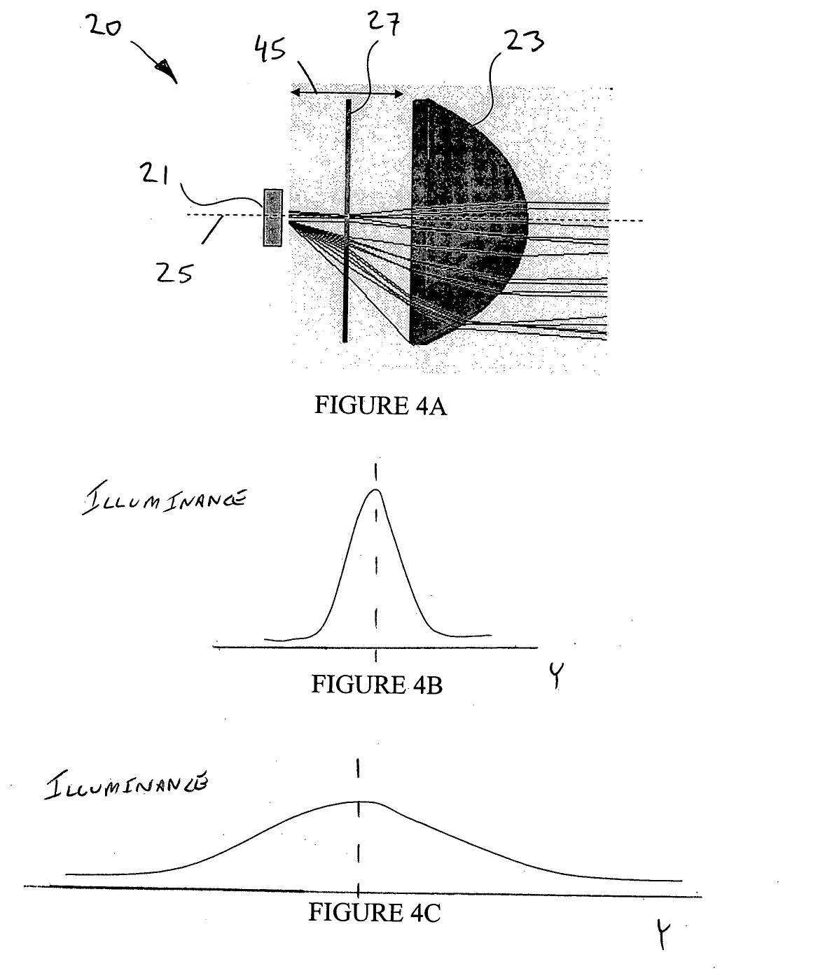

FIG. 4A shows the lighting system 20 wherein the diffuser 27 can be translated longitudinally in a direction substantially parallel to the optical axis 25 as indicated by arrow 45. In addition to having the diffuser 27 located proximal to the light source 21 or the projection lens 23, the diffuser may be midway therebetween (as shown). Moreover, the diffuser 27 may be at any longitudinal position between the light source 21 and the projection lens 23. As discussed more fully below, a translation mechanism may be included to cause the diffuser 27 to be longitudinally displaced as desired.

The beam pattern will vary accordingly. FIG. 4B is a plot of illuminance versus position (y) for a beam produced by the lighting system 20 depicted in FIG. 4A but with the diffuser 27 proximal to the light source 21. FIG. 4C is a plot of illuminance versus position (y) for a beam produced by the lighting system 20 depicted in FIG. 4A but with the diffuser 27 proximal to the projection lens 23. These plots of illuminance versus position are representative of the spatial beam pattern, or spatial distribution of light within the beam, which may be circularly symmetric. The narrower beam pattern shown in FIG. 4B is referred to as a “spot” pattern. Conversely, the broader beam pattern shown in FIG. 4C is referred to as the “flood” pattern. The spot pattern and the flood pattern are produced by the lighting system 20 in “spot” and “flood” modes, respectively. With the diffuser 27 disposed at intermediate locations, such as midway between the light source 21 and the projection lens 23 (as shown in FIG. 4A), the beam pattern will have a shape and size in a range between the spot pattern shown in FIG. 4B and the flood pattern shown in FIG. 4C.

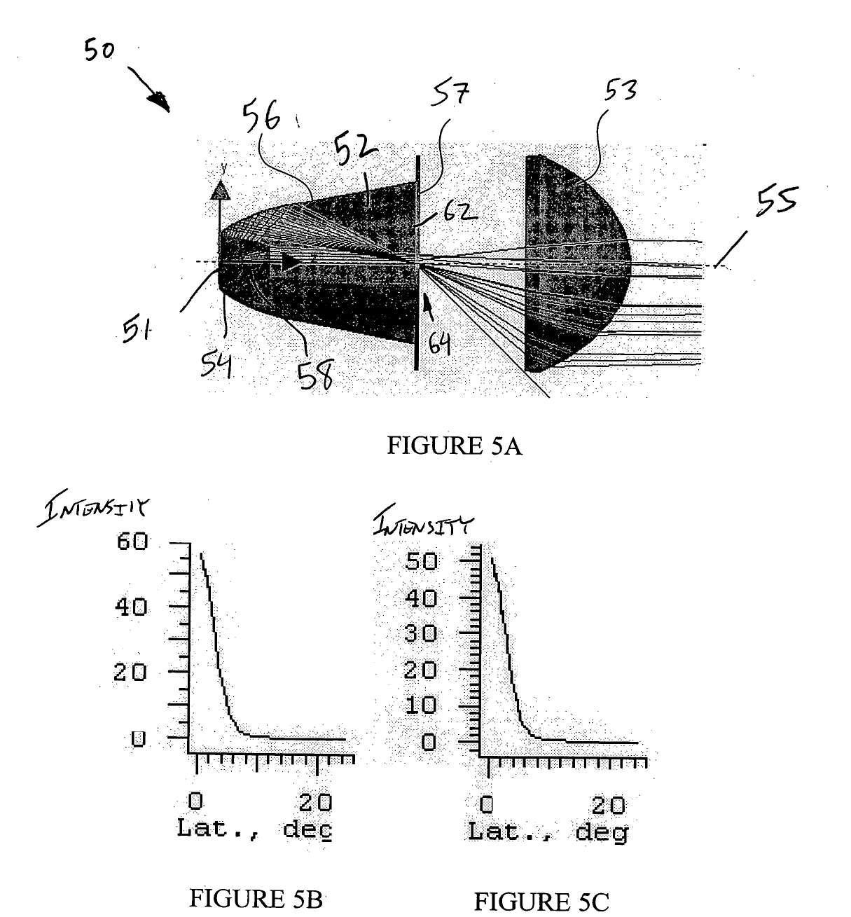

Other configurations are possible. FIG. 5A shows a lighting system 50 comprising a light source and a projection lens 53 disposed along an optical axis 55. A diffuser 57 is disposed therebetween. The lighting system 50 further comprises a collector 52 for collecting light from the light source 51. In certain embodiments, the light source 51 comprises a solid state emitter such as a light emitting diode (LED). This LED may be encased in a bullet shaped package 54 as shown.

The collector 52 may comprise a reflective optical element having reflective surfaces 56 for reflecting light emitted by the light source 51. The light may propagate within material forming the collector 52 and the light may be reflected from the reflective surfaces 56 via total internal reflection. The light source 51 may be included in a recess 58 in the material forming the collector 52. An example of such a collector 52 is described in U.S. Pat. No. 6,819,505 entitled “Internally Reflective Ellipsoidal Collector with Projection Lens,” which is incorporated herein by reference in its entirety.

In certain embodiments, this collector 52 comprises a non-imaging optical element. The reflective surfaces 56 may have a wide variety of shapes including aspheric. In some embodiments, for example, the surfaces 56 are ellipsoidal. Other types of collectors are also possible.

In the embodiment shown, the collector 52 has an output face 62 and a focus 64 where light is focused or at least substantially concentrated. This focus 64 need not be a point, but may comprise a region where the light is substantially concentrated. As shown in FIG. 5A, a plurality of rays of light emitted by the light source 51 pass through this focal region 64.

A wide range of collectors 52 are possible. The collector 52 need not be a non-imaging optical element and the surfaces 56 need not reflect by total internal reflection. Other collectors 52 may have surfaces that may be shaped differently. Refraction, diffraction, or other optical properties may be employed to collect and control the propagation of light from the emitter source 51. Multiple elements may be used. The collector 52 is not to be limited to the collector described herein as other collectors, both those well known in the art as well as those yet to be devised, may also be employed. For example, the collector 52 may comprise an elliptical reflector comprising specular reflecting surfaces having the light source 51 disposed within the elliptical reflector such that light from the light source is reflected from the elliptical collector. In other embodiments, the lighting system 50 may include a light source 51 with tapered angle-to-area converter. In certain embodiments, the collector 52 comprises a non-imaging tapered mixing rod that concentrates the light in a region. The collector 52 does not need to be rotationally symmetric nor does the light in the focal region 64 need to be rotationally symmetric. The collector 52 can also create multiple focal regions 64 where different projection lenses 53 are used with each of the focal regions. Other configurations and designs are also possible.

In FIG. 5A, the diffuser 57 is disposed proximal to the collector 52 and in particular is positioned by the output face 62 of the collector. This configuration is referred to as the “spot” mode because a narrow beam pattern is produced. In fact, adding the diffuser 57 at the output face 62 of the collector 52 does not substantially alter the performance of the lighting system 50. The lighting system 50 produces a relatively narrow beam both with the diffuser 57 at this location by the collector 52 as well as with the diffuser removed altogether. The diffuser 57 may, however, provide a smoother, more homogenous spatial beam pattern that does not have many local variations in intensity.

FIGS. 5B and 5C show plots of intensity versus ray angle for a beam pattern produced by the lighting system 20 depicted in FIG. 5A. The intensity may be in units of flux per steradian or candela, for example. The angle is measured with respect to the optical axis 55. Although the location along the Z axis is not critical, for convenience, one could assume the vertex of the curved surface on the projection lens 53 is the origin. Although only positive angles are shown in these plots, the beam pattern is includes both positive and negative angles. These plots of intensity versus angle are representative of the angular beam pattern or angular distribution of light within the beam, which may be circularly symmetric. These plots are relatively narrow indicating that the beam is narrow, with light tightly concentrated at low propagation angles and in the center of the beam. As described above, such a narrowly concentrated pattern is referred to as a “spot” pattern.

FIG. 5B plots the results for the lighting system 50 of FIG. 5A with the diffuser 57 disposed proximal to the collector 52, wherein the diffuser has an angular spread, δ, of 6 degrees. FIG. 5C is for a diffuser 57 having an angular spread, δ, of 12 degrees. Collimated light incident on such diffusers 57 will spread light into a range of angles from 0 to ±6 and 0 to ±12 degrees, respectively. Such diffusers 57 are referred to herein as 6° and 12° diffusers, respectively. In certain embodiments, the diffuser scatter distribution is

$$I ( θ ) = I ( 0 ) exp ( - 0.5 ( \frac{{θ}^{2}}{{δ}^{2}} ) ) ,$$

where θ is the angle from the optical axis.

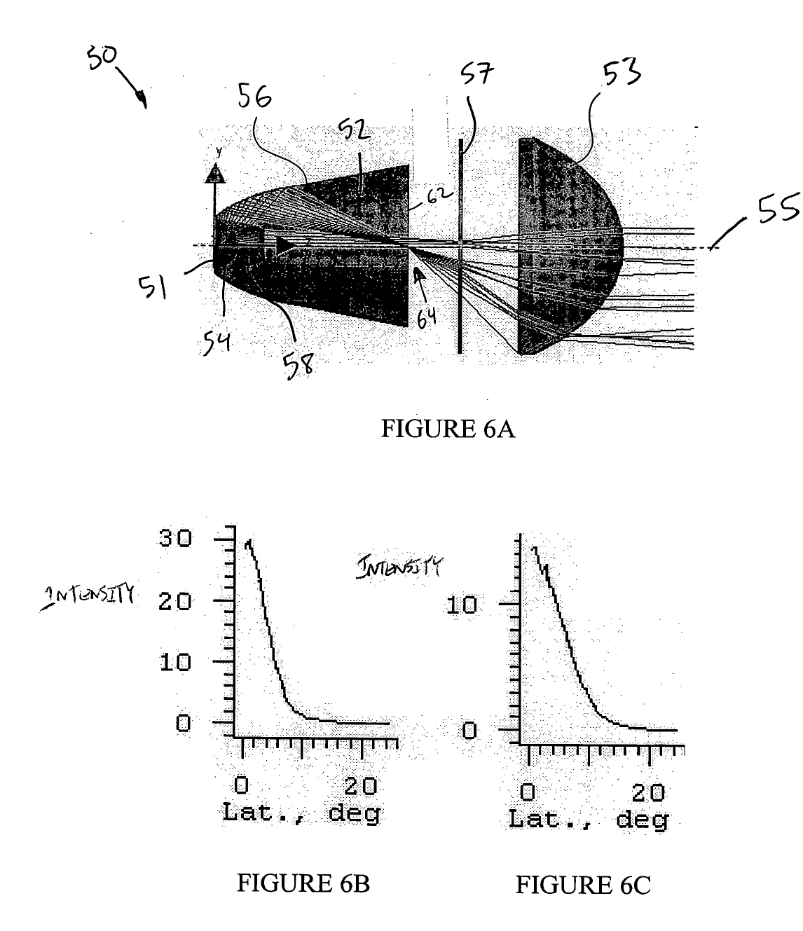

This Gaussian scatter distribution was used to model the diffusers 57 and produce the results plotted in FIGS. 5A and 5B (as well as for FIGS. 6A, 6B, 7A, 7B, 8B-8F, 9B-9F, 10A-10C, 13A-13C, 14B and 14C). All those simulations were performed using LightTools® from Optical Research Associates, Pasadena, Calif. The diffuser scatter distribution may be different in different embodiments and can be tailored for particular applications. For some applications, for example, the diffuser scatter distribution may have a uniform scatter versus angle or may even have its peak at angles away from the optical axis 55 so as to potentially create a more uniform output in the flood mode. Gaussian scatter is easily obtained, however, a more top-hat type of distribution is often desirable so as to reduce or maximize the spread in flood mode and increase or maximize the efficiency in spot mode.

A comparison of the plots in FIGS. 5B and 5C illustrates that the distribution of light in the beam does not change much as the diffuser spread angle, δ, increases.

Shifting the diffuser 57 toward the projection lens 53 increases the width of the beam. FIG. 6A shows the lighting system 50 wherein the diffuser 57 is about midway between the collector 52 and the projection lens 53. FIGS. 6B and 6C show plots of intensity versus ray angle for a beam produced by the lighting system 50 depicted in FIG. 6A. The central peaks in these plots have a lower intensity and are wider than those shown in FIGS. 5B and 5C. Accordingly, the beam is less tightly concentrated at low propagation angles and in the center along the optical axis 55.

FIGS. 6B and 6C plot the results for diffusers 57 having angular spreads, δ, of 6 degrees and 12 degrees, respectively. A comparison the plots in FIGS. 6B and 6C illustrates that the distribution of light in the beam does change as the diffuser spread angle, δ, increases when the diffuser 57 is located midway between the collector 52 and the projection lens 53.

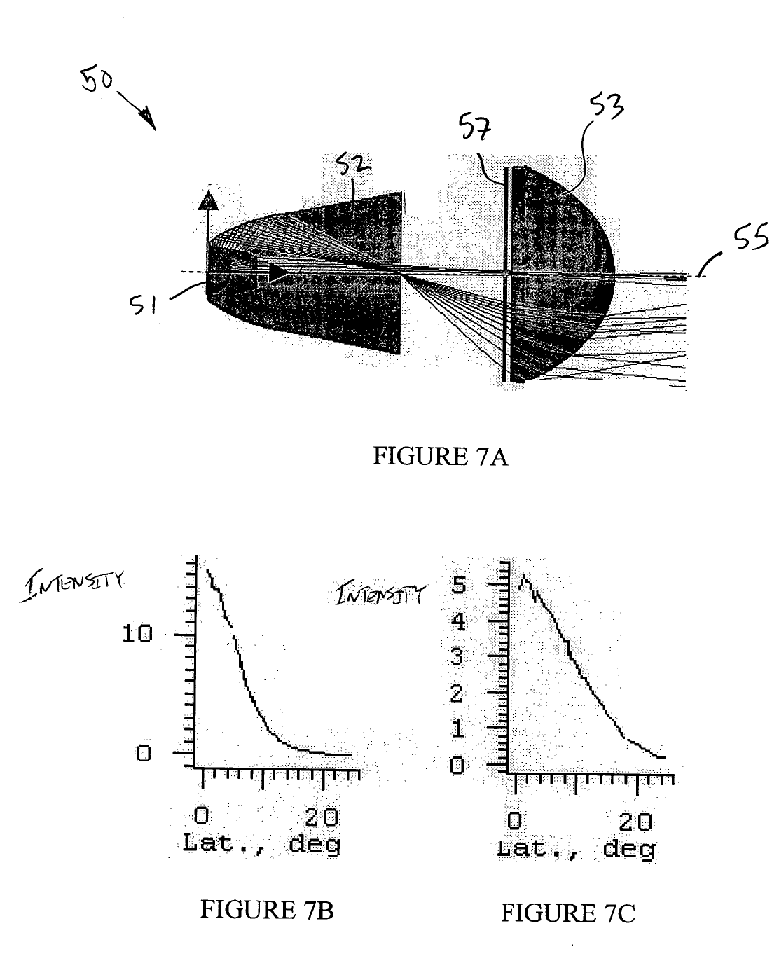

Shifting the diffuser 57 further toward the projection lens 53 increases the width of the beam. FIG. 7A shows the lighting system 50 wherein the diffuser 57 is proximal to the projection lens 53. FIGS. 7B and 7C show plots of intensity versus ray angle for a beam produced by the lighting system 50 depicted in FIG. 7A. The central peaks in these plots are wider and have less intensity than those shown in FIGS. 6B and 6C. These central peaks are much wider and have much less intensity compared to the central peaks shown in FIGS. 5B and 5C wherein the diffuser 57 is proximal to the collector 52. Accordingly, the beam is less tightly concentrated at low propagation angles and in the center along the optical axis 55 when the diffuser 57 is moved closer to the projection lens 53. As described above, this less tightly concentrated pattern is referred to as a “flood” pattern.

FIGS. 7B and 7C plots the results for diffusers 57 having angular spreads, δ, of 6 degrees and 12 degrees, respectively. A comparison the plots in FIGS. 7B and 7C illustrates that the distribution of light in the beam does change as the diffuser spread angle, δ, increased when the diffuser 57 is located proximal to the projection lens 53.

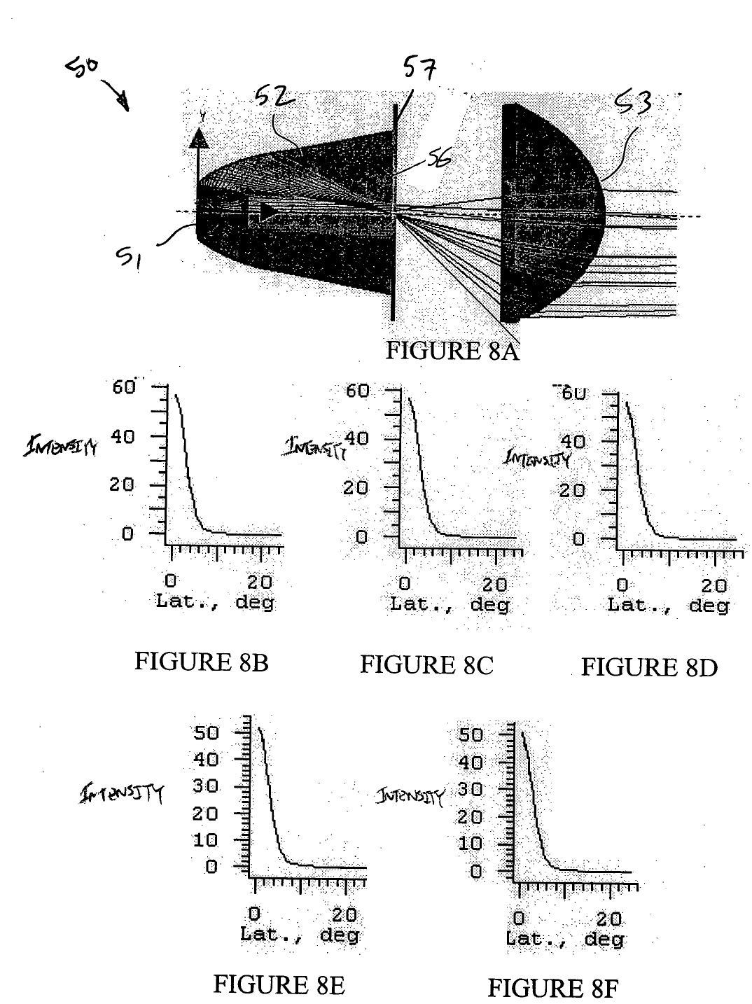

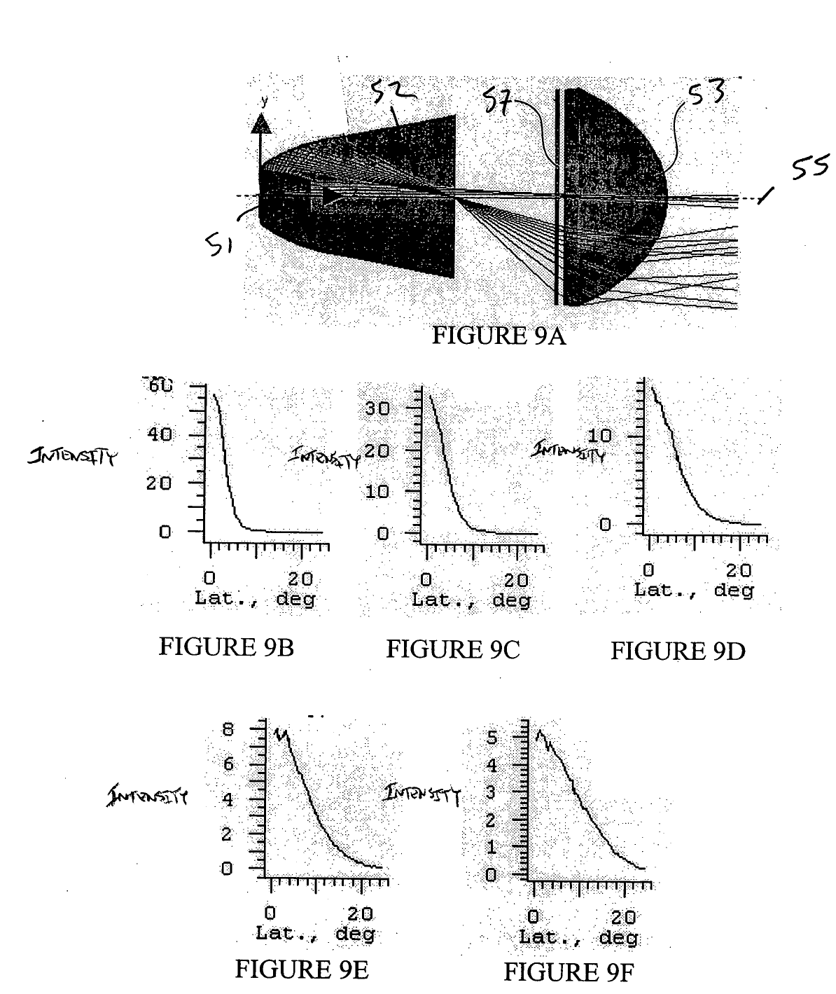

The enhanced effect of the diffuser spread angle, δ, on the beam pattern when the diffuser 57 is disposed closer to the projection lens 53 is illustrated in FIGS. 8A-8F and FIGS. 9A-9F. FIG. 8A, for convenient reference, shows the lighting system 50 with the diffuser 57 at the front face 56 of the collector 52. FIGS. 8B-8F show the angular beam patterns that result when using diffusers 57 having diffuser spread angles, δ, of 0°, 3°, 6°, 9°, and 12°, respectively. The central peaks in the angular beam patterns remain substantially the same for each of these diffuser spread angles: 0°, 3°, 6°, 9°, and 12°.

FIG. 9A, for convenient reference, shows the lighting system 50 with the diffuser 57 at the projection lens 53. FIGS. 9B-9F show the angular beam patterns that result when using diffusers 57 having diffuser spread angles, δ, of 0°, 3°, 6°, 9°, and 12°, respectively. The width of the central peaks in the angular beam patterns progressively increase with increasing diffuser spread angles: 0°, 3°, 6°, 9°, and 12°. Accordingly, the width of the “flood” beam pattern can be increased by increasing the diffuser spread angle, δ. Wider distributions are obtained with wider angle diffusers. Advantageously, the “spot” beam pattern remains relatively narrow.

Diffusers with larger diffuser spread angles, δ, can therefore nominally provide larger zoom ratios. Zoom ratio is defined as the beam angle in flood mode divided by the beam angle in spot mode.

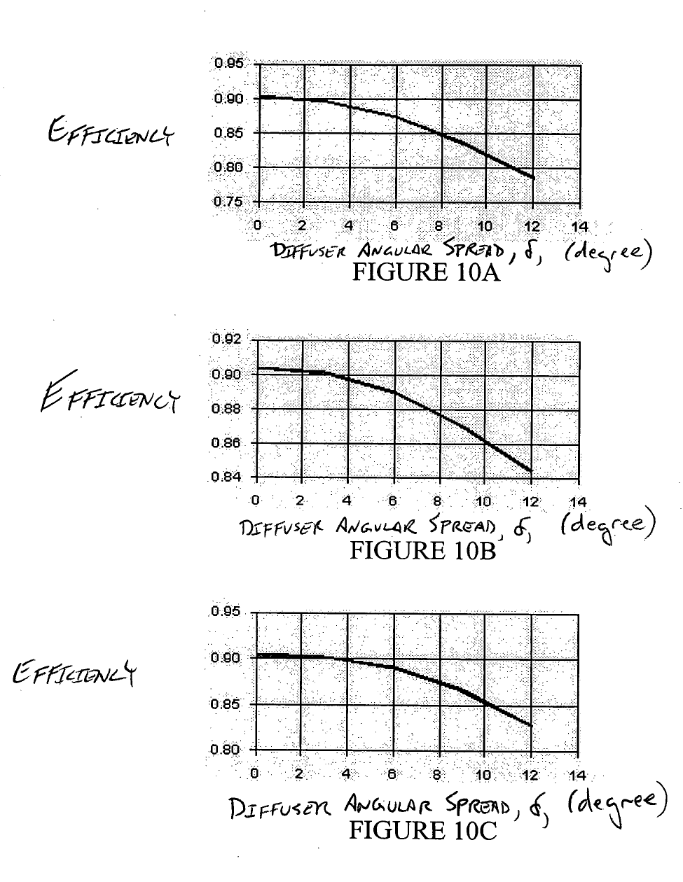

FIGS. 10A-10C show the effects of increasing the diffuser spread angles on efficiency. Efficiency in these calculations is obtained by dividing the flux output from the source 51 by the flux exiting the projection lens 53. The efficiency is a relative value since the efficiency for a 0° diffuser, for example, depends on the specific source employed, whether anti-reflective coatings are present, etc. FIG. 10A is a plot of efficiency versus diffuser angular spread, δ, for a configuration such as shown in FIG. 5A wherein the diffuser 57 is proximal to the collector 52. The efficiency deceases with larger diffuser spread angles, δ, although the efficiency change may be small.

FIG. 10B of is a plot of efficiency versus diffuser angular spread, δ, for a configuration such as shown in FIG. 6A wherein the diffuser 57 is midway between the collector 52 and the projection lens 53. FIG. 10C is a plot of efficiency versus diffuser angular spread, δ, for a configuration such as shown in FIG. 7A wherein the diffuser 57 is proximal to projection lens 53. Both of these plots in FIGS. 10B and 10C show that the efficiency deceases with larger diffuser spread angles, δ. A comparison of the plots in FIGS. 10A-10C, however, shows that the efficiency does not change substantially with location of the diffuser 57. For a given diffuser spread angle, δ, the efficiency is substantially the same when the diffuser 57 is proximal to the collector 52, midway between the collector and the projection lens 53, or proximal to the projection lens. These changes in collection efficiency are for a specific design where the projection lens 53 has a numerical aperture (N.A.) that substantially matches β, the angle subtended by the marginal ray as discussed above. The projection lens collection NA can be increased to match β+δ, to improve the collection efficiency with larger diffuser angles, δ.

A comparison of the plots in FIGS. 5B, 6B, and 7B show that shifting the diffuser 57 from the focus region 64 of the collector 52 toward the projection lens 53 provides a smooth and gradual increase in the beam spread. Similarly, a comparison of the plots in FIGS. 5C, 6C, and 7C show a smooth and gradual increases in the width of the beam pattern as the diffuser 57 is moved from the focus region 64 of the collector 52 toward the projection lens 53. The beam angle increases by more than about two times from spot mode to flood mode when using a 6° diffuser; (see FIGS. 5B and 7B). The beam angle increased by more than about three times from spot mode to flood mode when using a 12° diffuser; (see FIGS. 5C and 7C).

The peak intensity, however, is reduced as the diffuser is translated. The peak intensity decreases by a factor of about four from spot mode to flood mode when using a 6° diffuser; (see FIGS. 5B and 7B). The peak intensity decreases by a factor of about ten from spot mode to flood mode when using a 12° diffuser; (see FIGS. 5C and 7C).

These examples illustrate that a zoom illumination system 50 can be provided that outputs a beam that can be adjusted to produce different beam patterns. For example, in a “spot” mode, a bright, localized spot pattern may be produced. In a “flood” mode, a wider area may be flooded with light. In certain embodiments, the illumination system 50 may have intermediate settings to provide a variety of beam patterns ranging from highly concentrated to widely dispersed.

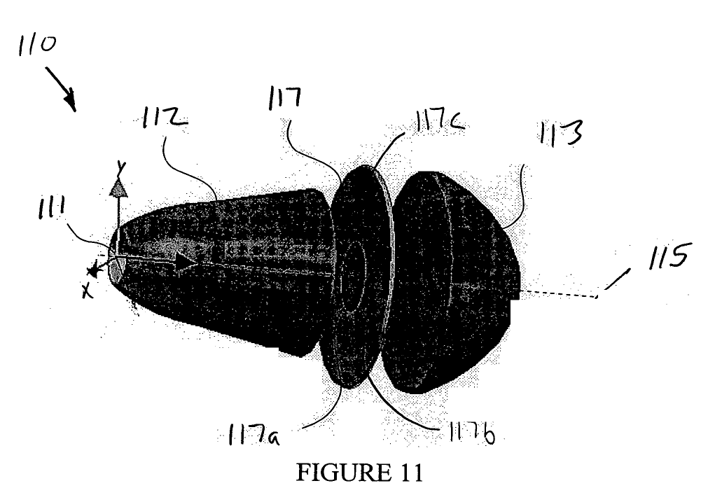

Other designs may be employed. FIG. 11 shows a lighting system 110 comprising a light source 111 and a projection lens 113 arranged along an optical axis 115. The lighting system 110 further comprises a collector 112 and a diffuser 117 disposed between the collector and the projection lens 113. In the embodiment shown, this diffuser 117 has a central circular region 117a that is surrounded by an annular region 117b. Light incident on the central circular region 117a is scattered differently than light incident on the surrounding annular region 117b. For example, the diffuser 117 may have a diffuser angular spread, δ, in the central circular region 117a that is smaller than the diffuser angular spread, δ, for the annular region 117b. In certain exemplary embodiments, the diffuser angular spread, δ, in the circular region 117a is less than or equal to about twice the arctangent (a/f), where a is the spot size (e.g., full width at half maximum) of the light concentrated in the focus region and f is the focal length of the projection lens. The diffuser angular spread, δ, in the surrounding annular region 117b may be at least the arctangent (a/f). Values outside these ranges, however, are possible.

As described above, the collector 112 may collect and concentrate light emitted from the light source 111 to a focus region (not shown). In the spot mode, the diffuser 117 may be positioned proximal to this focus region. At this focus region, light is mainly concentrated close to the optical axis 115. In certain embodiments, this central region 117a is just about the size of the focus region or slightly larger although the central region may be larger or smaller. In certain embodiments, the portion of the optical beam having an intensity of between 10% and 50% maximum intensity pass through the central region 117a, although values outside this range are possible. Accordingly, most of the light will propagate through the central circular region 117a when the diffuser 117 is disposed at the focus region. Since the diffuser spread angle, δ, is relatively small in the central circular region 117a, the light will not be scattered or spreader widely. A highly concentrated spot pattern can thereby be achieved.

When the lighting system 110 is in the flood mode, the diffuser 117 may be placed closer to the projection lens 113 where more of the diffuser is illuminated. In particular, more light will propagate through the surrounding annular region 117b, which has a larger diffuser spread angle, δ. These light rays will thus be scattered or spread more. As discussed above, larger diffuser spread angles, δ, yield wider beam patterns. The width of the beam pattern may thereby be increased when the lighting system 110 is in the flood mode.

In certain embodiments, the diffuser 117 comprises a third peripheral region 117c at the outer edges of the diffuser. This third peripheral region 117c has reduced diffuser spread angle, δ. In certain embodiment, for example, the diffuser angular spread, δ, in the peripheral region 117c may be between 0.1 and 0.5 times the angular spread in the second region 117b, although the value is not limited to this range. The steepest portions of the projection lens 113 might be at the outer edges. High scattering introduced at this region 117c might increase stray light. Reduced diffuser spread angle, δ, might decrease scattering or spreading and provide more beam control and less stray light.

More generally, the diffuser 117 may have a diffuser spread angle, δ, that varies across the lateral spatial extent of the diffuser (e.g., along the X and Y axes in FIG. 11). Accordingly, the diffuser 117 may have a scatter angle profile tailored for a particular design or application. A wide range of such designs are possible. The diffuser spread angle, δ, can vary in any manner suitable. Other parameters may also vary with lateral position on the diffuser 117.

A wide variety of configurations and designs are possible. In certain embodiments, for example, the central region 117a or other regions of the diffuser 117 comprise separate diffusers with separate properties. These separate diffusers may have diffusing features with different properties or diffusing features arranged or configured differently. These regions 117a may, for example, comprise different material. In other embodiments, the properties of the same diffusing component may varied at different locations or in different regions. Diffusing features with different properties or diffusing features arranged or configured differently may be distributed as desired across the diffuser 117 to provide the suitable profile. In various preferred embodiments, instead of the angular spread changing abruptly between discrete regions, the angular spread may changes substantially continuously or progressively from one region to another.

In one exemplary embodiment, the diffuser 117 may comprise asymmetric scatter features whose orientation varies as a function of azimuth about the optical axis 115. For example, scatter features may provide a 12°×0.1° angular spread at an azimuth of 0° and a 0.1°×12° angular spread at an azimuth of 90°. Similar angular spreads might be provided for 180° and 270°, respectively. The angular spread might change progressively between these angular spread values for intermediate azimuth points. Such a configuration could provide spreading yet reduce or minimize the fraction of light that misses the projection lens 113.

In various embodiments, the regions 117a, 117b, 117c may have different shapes than shown in FIG. 11 and need not be centrally located (e.g., aligned with the optical axis 115). Multiple such regions may also be employed. In certain embodiments, regions may be less well defined with less distinct boundaries. As discussed above, diffusing properties may vary more continuously across the diffuser 117. Still other configurations and designs are possible.

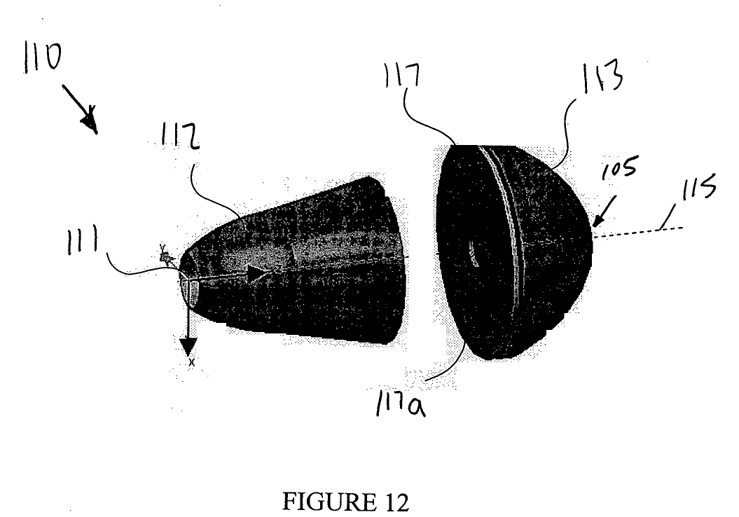

In another embodiment shown in FIG. 12, the central region 117a comprises a hole or an optical aperture. The annular region 117b surrounds the hole. As shown, this central region 117a is centered about the optical axis 115.

In the spot mode, the diffuser 117 may be positioned proximal to the focus region of the collector 112. At this focus region, light is mainly concentrated close to the optical axis 115. In certain embodiments, this central aperture region 117a is just about the size of the focus region or slightly larger, although the central region may be larger or smaller. For example, in certain embodiments, the portion of the optical beam having an intensity of between 10% and 50% maximum intensity passes through the central region 117a, although values outside this range are possible. Accordingly, most of the light will propagate through the central aperture circular region 117a when the diffuser 117 is disposed at the focus region. Without diffusing material in the central circular aperture region 117a, the light will not be scattered or spreader widely. Positioning the diffuser 117 near the collector focus will therefore not change the beam pattern. A highly concentrated spot pattern can thereby be achieved with no loss in efficiency created by the addition of the diffuser 117 in the spot mode.

When the lighting system 110 is in the flood mode, the diffuser 117 may be placed closer to the projection lens 113 where more of the diffuser is illuminated. In particular, more light will propagate through the surrounding annular region 117b which is diffusing. These light rays will thus be scattered or spread. The width of the beam pattern may thereby be increased when the lighting system 110 is in the flood mode.

In various embodiments, the hole 117a is small compared to the surrounding region 117b. Accordingly, only a small fraction of the flux that goes through the projection lens 113 in flood mode passes through the hole 117a. The hole 117a therefore does not adversely affect the contribution of the diffuser 117 toward producing a wide spot pattern in flood mode.

In some cases, a small on-axis peak may be introduced into the beam pattern as a result of the increase transmission through the hole 117a in the diffuser 117. To reduce or minimize this on-axis peak in the flood mode, a diffuser (not shown) may be applied to a central portion 105 of the projection lens 113. This smaller central diffuser will have negligible effect on the beam pattern in spot mode. However, in the flood mode, this central diffuser may attenuate or eliminate the on-axis peak that might appear especially if the flood pattern is extremely wide. This smaller central diffuser may be disposed elsewhere in the system 110 in other embodiments and may be incorporated into the projection lens 113 in some embodiments.

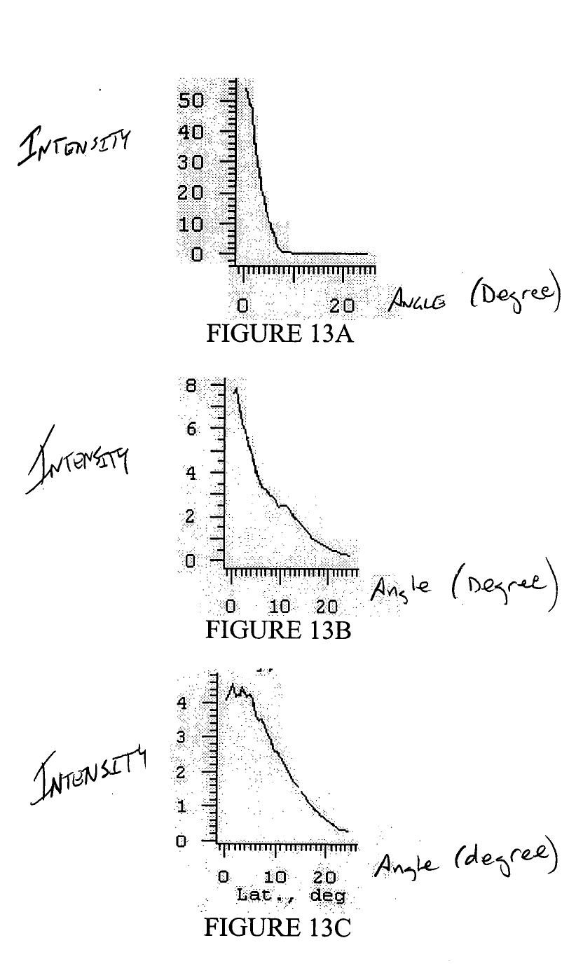

FIGS. 13A-13C illustrate the effectiveness of the central aperture 117a. FIGS. 13A-13C are plots of intensity versus ray angle for a beam produced by the lighting system 110 depicted in FIG. 12 but for various placements of the diffuser 117. The plot in FIG. 13A is for the spot mode wherein the diffuser 117 having the aperture 117a therein is proximal to the collector focus region. As shown, the beam pattern is relatively narrow, with light tightly concentrated at low propagation angles and in the center of the beam. The plot in FIG. 13B is for the flood mode wherein the diffuser 117 having the aperture 117a therein is proximal to the projection lens 113. As shown, the beam pattern is relatively wide, with more light distributed into higher projection angles and away from the center of the beam. These plots, however, do not include the effect of placement of a small diffuser at the center of the projection lens 113.

FIG. 13C is a plot for the flood mode wherein the diffuser 117 having the aperture 117a therein is proximal to the projection lens 113 and wherein the small diffuser is disposed at the central portion 105 of the projection lens 113. The flood beam pattern shown for this case is less peaked than the flood pattern shown in FIG. 13B where no diffuser was applied to the central portion 105 of the projection lens 113.

In certain embodiments, the hole 117a comprises an opening in the diffuser 117 devoid of material. Alternatively, the central region 117a may comprise an optical aperture comprising an optically transmissive material that substantially does not diffuse, scatter or spread light incident thereon. In some embodiments, the diffuser 117 comprises glass or polymer (plastic) with diffusing features in the surrounding region 117b but substantially devoid of features that diffuse, scatter, or spread the light in the central region 117a. Other designs are possible.

In other embodiments, for example, the aperture may have different shapes and need not be centrally located (e.g., aligned with the optical axis). Multiple apertures may also be employed.

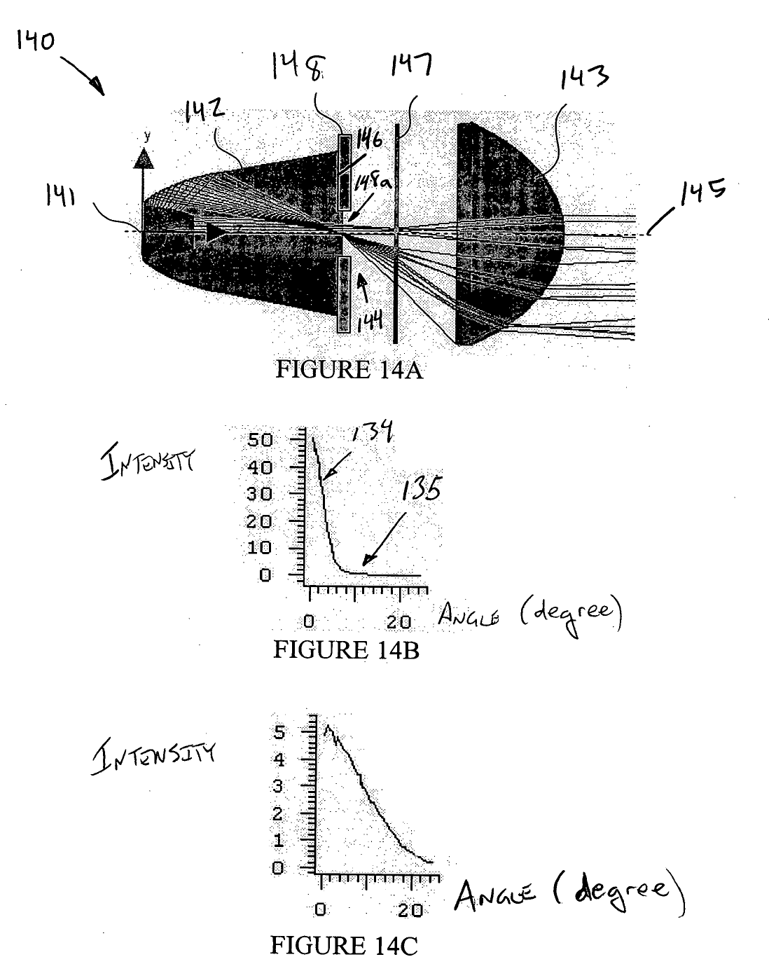

FIG. 14 shows another lighting system 140 comprising a light source 141 and a projection lens 143 arranged along an optical axis 145. The lighting system 140 further comprises a collector 142 and a diffuser 147 disposed between the collector and the projection lens 143. The collector 142 concentrates light in a region 144, referred to as a focus or focus region as discussed above. The lighting system 140 additionally comprises a mask 148 disposed between the diffuser 147 and the light source 141, and more particularly, between the diffuser and the collector 142. In the embodiment shown in FIG. 14A, the mask 148 is disposed proximal to or directly on a front face 146 of the collector 142.

The mask 148 includes a hole or aperture 148a therein. The aperture 148a in the mask 148 is centered about the optical axis 145 and is proximal to the focusing region 144 of the collector 142. In certain embodiments, the aperture 148a is circular. The aperture 148a may also be just about the size of the focus region 144 or slightly larger, although the aperture may be smaller or larger. Accordingly, most of the light will propagate through the aperture 148a.

The mask 148 may comprise substantially opaque material in some embodiments. The aperture 148a may be formed by a hole in this mask material 148. In some embodiments, the aperture 148a comprises substantially optically transmissive material, although the aperture may be substantially devoid of material in other embodiments.

In certain embodiments, the projection lens 143 images the distribution at the collector focus 144 to form the beam pattern. The presence of the mask 148 narrows the peak in the beam pattern when the lighting system 140 is in the spot mode. FIG. 14B shows a plot of the beam pattern for the lighting system 140 of FIG. 14A in the spot mode. The plot shows a central peak 134 and a tail region 135 with reduced intensity. The mask 148 reduces or minimizes the intensity in the tail region.

FIG. 14C shows a plot of the beam pattern for the lighting system 140 of FIG. 14A in the flood mode. The plot shows a widened central peak 134. More light is distributed into higher beam angles.

Having a dramatic increase in intensity at higher beam angles when moving from spot mode to flood mode may be desirable for some applications. With the mask 144, shifting the diffuser 147 from the collector 142 to the projection lens 143 produces a dramatic increase in the intensity measured or observed at higher angles (see, e.g., 10°).

The mask 148 and aperture 148a may be configured differently than shown in FIG. 14A and described above. For example, the aperture 148a may have different shapes than shown in FIG. 14A and need not be centrally located (e.g., aligned with the optical axis 145). Multiple such apertures 148a may also be employed. Still other configurations and designs are possible.

A wide range variation is possible in the configuration and design of the lighting systems. For example, the light sources may be different. The source of light can be an emitter or an optical system that outputs light. In one exemplary embodiment, such an optical system creates a prescribed illuminance distribution.

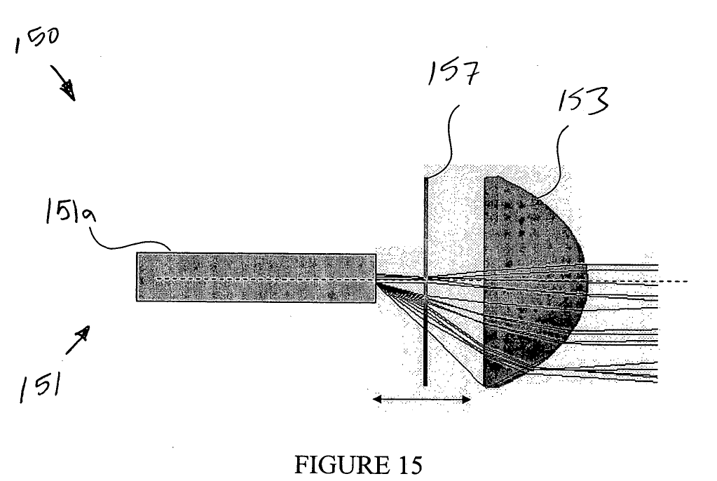

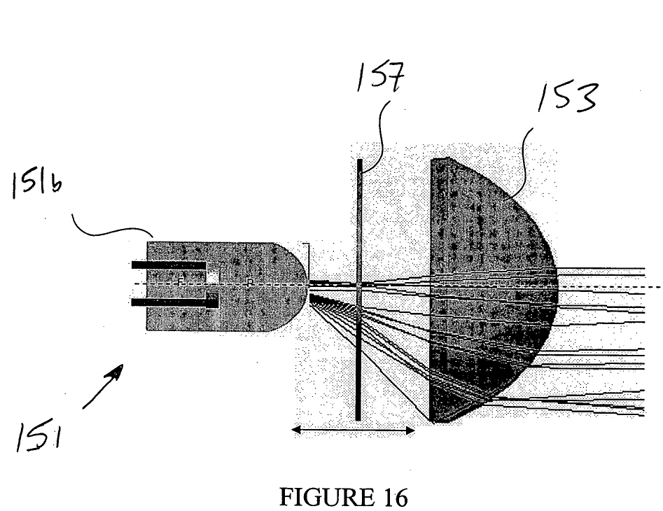

FIGS. 15 and 16 show lighting systems 150 comprising a light source 151, a diffuser 157, and a projection lens 153, wherein the light source comprises a fiber optic 151a and a light emitting diode 151b, respectively. The fiber optic 151a may comprise an optical fiber, a fiber bundle, a fiber delivery system possibly including beam shaping optics, etc. In some embodiments, a light pipe, light guide, or conduit may be used. The light emitting diode 151b in FIG. 16 may comprise, for example, a conventional T 1¾ LED with a bullet package 151b. The light source 151 can include optics such as the refractive surface of the bullet lens or a reflective parabolic collector for an incandescent bulb. Laser diodes as well as fluorescent lighting can be used in other embodiments. Multiple light sources may be employed. For example, a surgical light may comprise multiple light sources having a diffusing optical element disposed in front of the light sources. This diffusing optical element may comprise, for example, a single diffusing optical element such as a single diffuser that extends across the plurality of light sources. An array of projection lens may be disposed forward of the diffuser. Other types of light sources including those not recited herein and those yet to be devised may also be employed.

A collector may or may not be used. Such collectors may include non-imaging optical components and reflective components although other types may also be used including those not recited herein and those yet to be devised. The collector may include multiple elements in certain embodiments.

A wide variety of diffusers may be used. The diffuser may, for example, comprise surface or volume features that scatter or diffuse light. Examples of some surface features include textured surfaces and surfaces with small curved or non-curved portions that refract or diffract light. Examples of volume structures include particulates imbedded in a material that reflect, refract, or scatter light as well as index of refraction variations. Other diffusing features are also possible. The features may have varying degrees of randomness ranging from random and pseudo-random to periodic and orderly. The degree of randomness and order may be different for microscopic and macroscopic regions.

In some embodiments, the scatter features may be arranged to provide different optical effects. For example, the diffusers may be configured to have a particular diffuse angular spread, δ. The diffusers may have a diffuse angle, δ, that varies across the diffuser in a suitable manner as described above. The diffuser may be configured to distribute light in a symmetric or asymmetric pattern. For example, the diffusers may be configured to produce a circular or elongated beam. The diffusers may have a diffuse angular spread, δ, that is higher along one direction (e.g., X) than along another direction (e.g. Y). Exemplary diffusers may provide angular spreads, for example, of 60°×1° or 70°×0.1°, although a wide range of angle spreads are possible. Accordingly, beams may be provided that are substantially collimated in one direction and spread along another direction. These directions, however, need not be orthogonal. More complex beam patterns are also possible.

The diffusers may comprise glass, polymer (e.g. plastic), or other material. In some embodiments, the diffusers comprise polymer dispersed liquid crystal. The diffuser may have any shape. Diffusers having curvature, for example, to provide optical power may be used. The cross-section of the diffuser may have other shapes as well. Additionally, although circular diffusers are shown, the diffusers may be square, rectangular or have other shapes.

The diffusers may provide a diffusing effect by refraction, reflection, diffraction, scattering, or combinations thereof. Other effects may be employed as well.

The diffusers may comprise diffractive optical elements or holographic elements. Engineered diffusers may be used. Certain types of engineered diffusers comprises a plurality of lenses (or lenslets) with different characteristics (e.g., power, size, shape, center-to-center spacing) in a random or pseudo-random arrangement. Certain engineered diffusers are available from RPC Photonics, Inc., Rochester, N.Y.

More generally, a diffusing optical element may be used. Such a diffusing optical element or non-imaging light spreading optical element or angle spreading element is an optical element that spreads light to a range of angles in a manner to provide a diffusing effect. Diffusers such as described above are examples of diffusing optical elements. Other examples include a plurality of lenslets arranged in a lens array or otherwise. Such lenslets may comprise microlenses. In one example, cylindrical lenslets are used to produce asymmetric or non-circularly symmetric beams. Symmetric lenslets may also be used. Arrays of tapered elements can be used as well. Other diffusing optical elements may also be employed.

The discussions above with respect to diffusers also apply to other types of diffusing optical elements. For example, the diffusing optical elements may comprise a variety of different materials, may range from random or pseudo-random to partially or totally ordered or periodic. For example, the lenslets may be arranged randomly or orderly. The diffusing optical elements may operate by reflection, refraction, diffraction, scattering or any combination thereof. The diffusing optical element may be configured to produce a non-circularly symmetric (e.g., elliptical) beam pattern. The diffusing optical element may have any shape.

Similarly, diffusing optical elements other than diffusers may be included in any of the systems described above and may have any of the features described above with respect to the diffusers. For example, the diffusing optical element may have a diffusing angle profile that varies across the diffusing optical element. The diffusing optical element may have one or more holes or optical apertures therein. A mask may be used in conjunction with the diffusing optical element. Other features may also apply to diffusing optical elements.

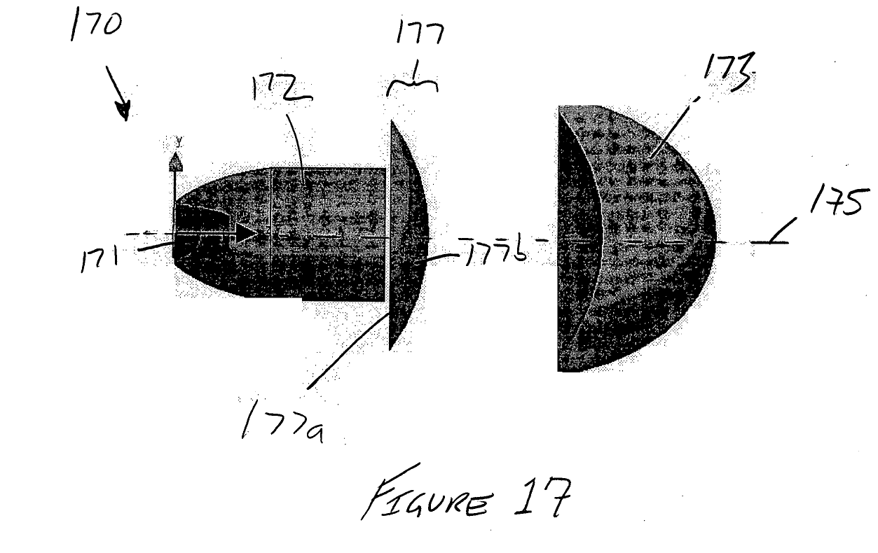

The diffusing optical element may comprise multiple components. For example, FIG. 17 shows a lighting system 170 comprising a light emitter 171, a collector 172, and a projection lens 173 together with a diffusing optical element 177 that comprises a diffuser 177a attached to a lens 177b. The diffusing optical element 177 can be translated longitudinally along the optical axis 175 to provide a spot beam pattern or a flood beam pattern. The diffusing optical element 177 may have other configurations than depicted in FIG. 17. For example, diffusing optical element 177 may be shaped differently. The lens 177b shown comprises a plano-convex lens, however, other types of lenses may be used and the surfaces may be shaped different. The size of the diffusing optical element 177 may vary. Additionally, the diffractive optical element 177 may include an aperture therein such as described above and may have variation in the diffusing property across the element.

The diffuser 177a can be integrated with the lens 177b in other ways. In certain embodiments, the diffusing optical element 177 may comprise a lens having a diffusing surface formed thereon. Other configurations and designs are also possible.

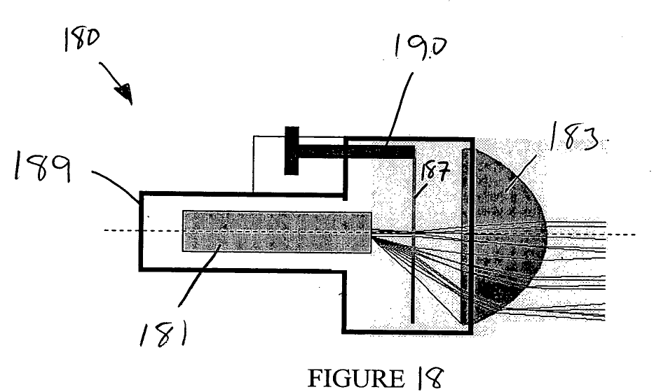

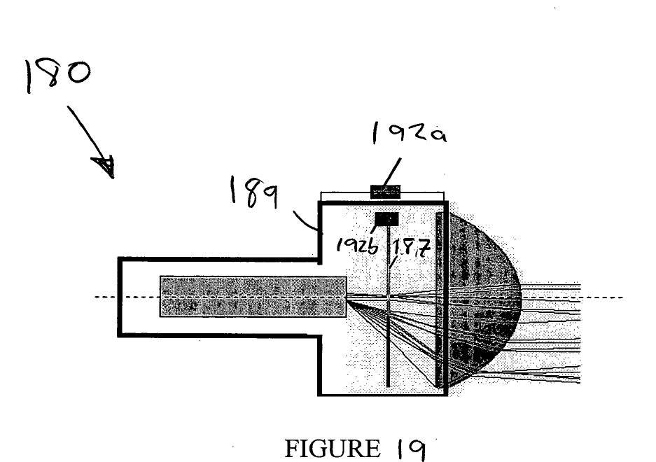

The diffusing optical element may be translated using a wide range of configurations. FIG. 18, for example, shows a lighting system 180 comprising a light source 181, a diffusing optical element 187, and a projection lens 183. The diffusing optical element 187 is in a housing 189. A pin or screw 190 is used to translate the diffusing optical element 187. FIG. 19 shows a configuration wherein magnets 192a, 192b outside and inside the housing 189 are used to move the diffusing optical element 187.

In other embodiments, pins are connected to the diffusing optical element. These pins fit in slots that guide the motion of the pins. The diffusing optical element can be translated by moving the pins in a longitudinal direction. In certain embodiments, the slots that guide the pins are angled such that rotation of the diffusing optical element induces translation thereof. In another embodiment, gears may be used to translate the diffusing optical element. Many other techniques for translating the diffusing optical element are possible.

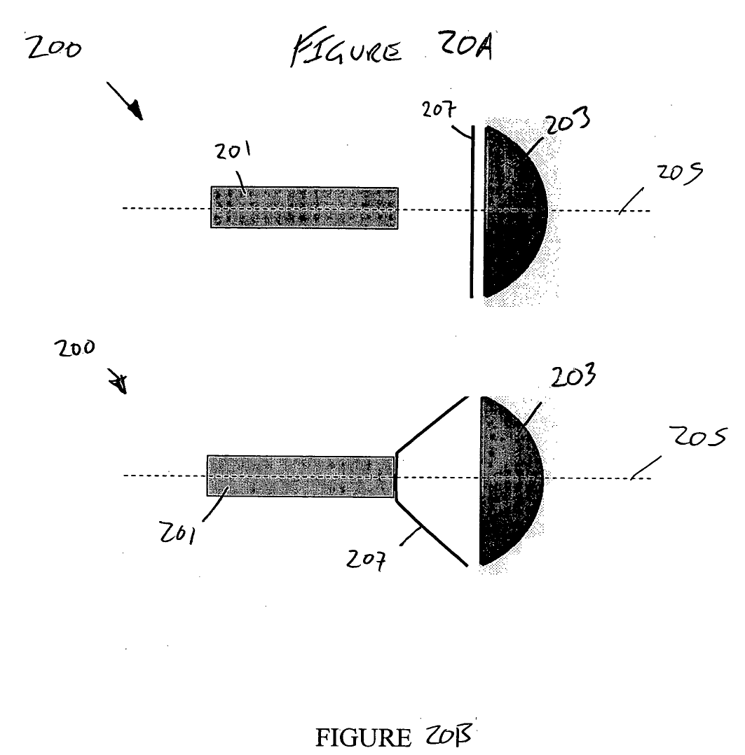

FIGS. 20A and 20B show another configuration for translating a diffusing optical element 207 comprising a flexible member. This flexible member may comprise, for example a membrane. The diffusing optical element 207 is disposed in a lighting system 200 between a light source 201 and a projection lens 203. The diffusing optical element 207, being flexible, and can be pushed or pulled toward the light source 201. In certain embodiments, for example, the region between the diffusing optical element 207 and the projection lens 203 is filled with air or gas that forces the flexible membrane to expand. A portion of the flexible membrane close to the optical axis 205 is pushed to the light source 201. In other embodiments, a region between the diffusing optical element 207 and the light source 201 can be evacuated causing the flexible member to be drawn toward the light source. In other embodiments, the flexible member may be attached to a structure that pulls the flexible member toward the light source 201.

In the case where the flexible member comprises a material such as a membrane that stretches, the flexible member may be less diffusing, have a smaller diffusing angular spread, δ, when the flexible member is stretched. Accordingly, when the diffusing optical element 207 is translated toward the light source 201, the angular spread, δ, may be reduced. The spot size may thus be made narrow. In contrast, the angular spread, δ, may be higher when the flexible member is not being stretched such as when the lighting system 200 is in the flood mode. The higher diffusing angular spread, δ, will provide for a wide distribution of light in the flood pattern. Other variations and configurations are possible.

In other embodiments, the diffusing optical element has a diffusing angular spread, δ, that is adjustable. For example, the diffusing optical element may be an electro-optic component having an angular spread, δ, that can be controlled by applying a signal thereto. In one exemplary embodiment, the diffusing optical element comprises polymer dispersed liquid crystal (PDLC). An electric field applied to the PDLC, for example, using electrodes, may alter the orientation of the liquid crystal causing the diffusing qualities of the diffusing optical element to be altered. Likewise, the diffusing angular spread, δ, can be altered electrically. In other embodiments, the diffusing optical element comprises magneto-optic material. Other configurations and designs are also possible. Accordingly, no moving parts are needed to adjust the diffuser scatter angle.

Variations in the projection lens are also possible. The projection lens may have a suitable focal length and be positioned with respect to the light source to substantially collimate the beam. In other embodiments, the focal length may be different and the projection lens may not be so positioned. For example, the location where the high angle light is best focused and the location where the low angle light is best focused may be different. The projection lens can be optimized for these differences. Additionally, although a plano-convex lens is shown, other types of lenses may be used. The lens may have surfaces shaped differently, may by asymmetric or non-circularly symmetric (e.g. elliptical), and may include multiple lens elements. In certain embodiments, the projection lens is a diffractive, Fresnel, TIR-Fresnel, or other type of lens. A reflector may also be used. Accordingly, the projection lens may be more generally referred to as projection optics to include these and other types of optical elements.

In certain embodiments, the projection optics images the surface of the diffuser. Minor irregularities may be observable in the beam pattern as a result. To reduce the occurrence of such irregularities in the beam, the projection optics may be diffusing. For example, a projection lens may include faceting. The faceting can be on either or both surfaces of the lens or portions thereof. The projection lens may also have surface features such as surface texture that is diffusing or may have volume features that are diffusing. The projection optics can be otherwise configured to increase the uniformity of the beam. In some embodiments, a diffusing optical element is disposed forward of the projection optics such that light propagating through the projection optics is diffused downstream.

Such configurations may advantageously smear fine structure in the beam pattern and still maintain desired beam shape. Low angular spread may be provided. Additionally, a highly asymmetric pattern or non-circularly symmetric (e.g., 50°×0.1° spread) may be provide by a diffusing optical element downstream of the projection optics or by projection optic configured to be diffusing. In such embodiments, translating the diffusing optical element between the light source and the projection optics might primarily adjust the spread in only one axis (e.g., in the axis with the 0.1° spread). Other embodiments are also possible.

In certain embodiments of the invention, the lighting systems are configured to produce at least about 10,000 nits, 100,000 nits, or 1,000,000 nits. Values outside these ranges, however, are possible in other embodiments.

In some embodiments, the lighting system comprises a flashlight, an automobile light, a bike light or other types of lights. Accordingly, the lighting system may comprise a housing for, e.g., a flashlight or bike light, and an enclosure and proper connections for, e.g., a headlight, etc. The lighting system may also comprise a light for track lighting, display lighting, architectural lighting, or down lighting, stage lighting or for other applications. Similarly, the lighting system may include a housing and/or mounting assembly and proper electrical connections for power for, e.g., track lighting, display lighting, down lighting, architectural lighting, stage lighting, etc.

In certain embodiments, the lighting system may comprise a solid state emitter module that includes a solid state emitter such as an LED or laser diode with or without a collector, a diffusing optical element, and projection optics. The solid state emitter module may further comprise a heat sink and circuitry for controlling power to the solid state emitter. The module may also include a housing that contains these components therein. The solid state emitter module can be attached to an assembly that provides power through, e.g., a battery or electrical power lines, to the solid state emitter module. The solid state emitter module can be attached to such an assembly to produce a light such as for example, a portable light (e.g., a flashlight) or fixed lighting (e.g., tracklighting or architectural lighting). Such attachment may be, for example, by snap fit, threading, welding, riveting, and may be glued, screwed together, bolted, or otherwise securedly connected.

A wide range of other variations in the configuration and design of the lighting systems are possible. The elements, for example, the light source, the collector, the diffusing optical element and the projection lens may have features different than described herein. Symmetric or asymmetric (non-rotationally symmetric) and on-axis or off-axis elements may be used. Additional optical elements may be added. The optical elements may be split up into separate parts or may be combined or integrated together. Elements may be removed.

The lighting system may be used in a wide range of applications. As discussed above, such lighting systems may be used, for example, for flashlights and other portable lights, automobile and bike lights, surgical lights, stage lighting, studio lighting, display case lighting, down lights, track lighting, architectural light, and other applications. These lighting devices may be used for medical, military, industrial, manufacturing, consumer, entertainment, or other applications. Aerospace and nautical applications are possible. Other uses are likely to be realized in the future.

Moreover, various embodiments of the invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A lighting system for providing lighting, said lighting system configured to produce a variable beam pattern, said lighting system comprising:
a light source;
a diffusing optical element; and
projection optics, said diffusing optical element disposed in an optical path between said light source and said projection optics, said projection optics projecting a beam having said beam pattern,
wherein said diffusing optical element is movable along said optical path thereby altering said beam pattern.

2. The lighting system of claim 1, wherein the light source is selected from the group comprising an optical fiber and a light emitting diode.

3. The lighting system of claim 1, wherein the light source is configured to produce at least about 10,000 nits in said beam pattern produced by said projection optics.

4. The lighting system of claim 3, wherein the diffusing optical element comprises a diffuser or an array of lenses.

5. The lighting system of claim 4, wherein said diffuser comprises surface scatterers or volume scatterers.

6. The lighting system of claim 4, wherein said diffuser comprises a holographic diffuser, a light shaping diffuser, or an engineered diffuser.

7. The lighting system of claim 4, wherein said diffuser comprises polymer dispersed liquid crystal.

8. The lighting system of claim 4, wherein said array of lenses comprises an ordered array of lenses, a random array of lenses or a pseudo-random array of lenses.

9. The lighting system of claim 8, wherein array of lenses comprises microlenses.

10. The lighting system of claim 3, further comprising an adjustable positioning device connected to said diffusing optical element to alter the position of said diffusing optical element.

11. The lighting system of claim 3, wherein the diffusing optical element is configured to be translated to the projection optics.

12. The lighting system of claim 3, wherein said projection optics comprises a projection lens.

13. The lighting system of claim 3, further comprising a collector disposed with respect to the light source to substantially focus light at a focus, said diffusing optical element being configured to be translated to said focus.

14. The lighting system of claim 1, wherein said diffusing optical element comprises a diffuser and a lens.

15. The lighting system of claim 1, further comprising a flashlight housing for forming a flashlight.

16. The lighting system of claim 1, further comprising a track lighting connector for connection with a track for track lighting.

17. The lighting system of claim 1, further comprising a bike light housing, an automobile light housing, an architectural light housing, a display case light housing, a surgical light housing, a stage light housing, or a studio light housing.

18. The lighting system of claim 1, wherein said light source, said diffusing optical element, and said projection optics are integrated together into a solid state emitter module.

19. A lighting system for providing lighting, said lighting system configured to produce a beam pattern, said lighting system comprising:
a light source;
a collector disposed with respect to said light source to substantially concentrate light at a focus;
projection optics configured to project a beam having said beam pattern; and
a diffusing optical element disposed in an optical path between said light source and said projection optics at a distance from said focus.

20. The lighting system of claim 19, wherein the light source is configured to produce at least about 10,000 nits in said beam pattern produced by said projection optics.

21. The lighting system of claim 20, wherein said collector comprises a reflective element having a reflective surface.

22. The lighting system of claim 21, wherein said collector comprises a non-imaging optical element.

23. The lighting system of claim 22, wherein the non-imaging optical collector comprises ellipsoidally shaped sidewalls.

24. The lighting system of claim 20, wherein said diffusing optical element is between said focus and said projection optics.

25. The lighting system of claim 20, wherein said diffusing optical element is closer to said projection optics than to said focus.

26. The lighting system of claim 20, wherein said diffusing optical element is closer to a rear side of said projection optics than to a front side of said collector.

27. The lighting system of claim 20, wherein said projection optics has a focal length and said diffusing optical element is at least about 10% of said focal length from said focus.

28. The lighting system of claim 19, wherein said focus is substantially disposed at a front face of said collector.

29. The lighting system of claim 19, wherein said diffusing optical element is closer to a front surface of said collector than a rear surface of said projection optics.

30. The lighting system of claim 19, further comprising a flashlight housing for forming a flashlight.

31. The lighting system of claim 19, further comprising a track lighting connector for connection with a track for track lighting.

32. The lighting system of claim 19, further comprising a bike light housing, an automobile light housing, an architectural light housing, a display case light housing, a surgical light housing, a stage light housing, or a studio light housing.

33. The lighting system of claim 19, wherein said light source, said diffusing optical element and said projection optics are integrated together into a solid state emitter module.

34. A lighting system for providing lighting, said lighting system configured to produce a beam pattern, said lighting system comprising:
a light source;
a diffusing optical element; and
projection optics, said diffusing optical element disposed in an optical path between said light source and said projection optics,
wherein said projection optics is configured to project a beam having said beam pattern and said projection optics is fixed with respect to said light source.

35. The lighting system of claim 34, wherein the light source is configured to produce at least about 10,000 nits in said beam pattern produced by said projection optics.

36. The lighting system of claim 35, wherein said diffusing optical element is movable to alter said beam.

37. The lighting system of claim 34, further comprising a flashlight housing for forming a flashlight.

38. The lighting system of claim 34, further comprising a track lighting connector for connection with a track for track lighting.

39. The lighting system of claim 34, further comprising a bike light housing, an automobile light housing, an architectural light housing, a display case light housing, a surgical light housing, a stage light housing, or a studio light housing.

40. The lighting system of claim 34, wherein said light source, said diffusing optical element and said projection optics are integrated together into a solid state emitter module.

41. A lighting system for providing lighting, said lighting system configured to produce a beam pattern, said lighting system comprising:
a light source;
a diffusing optical element configured to distribute light into a range of angles; and
projection optics, said diffusing optical element disposed in an optical path between said light source and said projection optics, said projection optics being configured to project a beam having said beam pattern,
wherein the diffusing optical element has a profile that determines the range of angles into which light is distributed at different locations across said diffusing optical element, said profile being configured such that the range of angles is different for different locations on said diffusing optical element.

42. The lighting system of claim 41, wherein the light source is configured to produce at least about 10,000 nits in said beam pattern produced by said projection optics.

43. The lighting system of claim 41, wherein said profile comprises a distribution profile that determines the range of angle into which light is distributed at different locations across said diffusing optical element.

44. The lighting system of claim 41, wherein the profile is configured such that the diffusing optical element distributes light into a wider range of angles in a region closer to a central axis than at locations farther from said central axis.

45. The lighting system of claim 44, wherein said region comprises a circular region substantially centered about an optical axis through said projection optics.

46. The lighting system of claim 45, wherein said circular region has diameter between about the size of an intermediate focus between said light source and said projection lens where said light is substantially concentrated.

47. The lighting system of claim 44, wherein said diffusing optical element has an angular spread in said region of about twice the arctangent (a/f) or less, where a is size of an intermediate focus between said light source and said projection lens where said light is substantially concentrated and f is the focal length of the projection optics.

48. The lighting system of claim 47, wherein said diffusing optical element has an angular spread of at least about said arctangent (a/f) outside said region.

49. The lighting system of claim 44, wherein the profile is configured such that the diffusing optical element has an angular spread that is less at locations proximal to peripheral edges the diffusing optical element than at locations away from said edges.

50. The lighting system of claim 41, further comprising a flashlight housing for forming a flashlight.

51. The lighting system of claim 41, further comprising a track lighting connector for connection with a track for track lighting.

52. The lighting system of claim 41, further comprising a bike light housing, an automobile light housing, an architectural light housing, a display case light housing, a surgical light housing, a stage light housing, or a studio light housing.

53. The lighting system of claim 41, wherein said light source, said diffusing optical element, and said projection optics are integrated together into a solid state emitter module.

54. A lighting system for providing lighting, said lighting system configured to produce a beam pattern, said lighting system comprising:
a light source;
an optical element having an optical aperture therein, said optical element having an optical property that is absent in said aperture; and
projection optics, said projection optics being configured to project a beam having said beam pattern, said optical element disposed in an optical path between said light source and said projection optics.

55. The lighting system of claim 54, wherein said optical element comprises a diffusing optical element.

56. The lighting system of claim 54, wherein said optical element comprises a diffuser and a lens.

57. The lighting system of claim 54, wherein the aperture is aligned with the light source.

58. The lighting system of claim 54, wherein said optical aperture is disposed along an optical axis through said light source and projection optics.

59. The lighting system of claim 54, wherein said optical aperture comprises substantially optically transmissive material.

60. The lighting system of claim 59, wherein said substantially optically transmissive material comprises glass or polymer.

61. The lighting system of claim 54, wherein the light source is configured to produce at least about 10,000 nits in said beam pattern produced by said projection optics.

62. The lighting system of claim 61, wherein said optical aperture is substantially devoid of angle spreading features.

63. The lighting system of claim 61, wherein said optical aperture comprises an opening devoid of material.

64. The lighting system of claim 61, wherein said optical element is movable along said optical path thereby to alter said beam.

65. The lighting system of claim 64, further comprising an adjustable positioning device connected to said optical element to alter the position of said optical element.

66. The lighting system of claim 54, further comprising a flashlight housing for forming a flashlight.

67. The lighting system of claim 54, further comprising a track lighting connector for connection with a track for track lighting.

68. The lighting system of claim 54, further comprising a bike light housing, an automobile light housing, an architectural light housing, a display case light housing, a surgical light housing, a stage light housing, or a studio light housing.

69. The lighting system of claim 54, wherein said light source, said diffusing optical element, and said projection optics are integrated together into a solid state emitter module.

70. A lighting system for providing lighting, said lighting system configured to produce a beam pattern, said lighting system comprising:
a light source;
a diffusing optical element;
projection optics, said projection optics configured to project a beam having said beam pattern, said diffusing optical element disposed in an optical path between said light source and said projection optics; and
a mask disposed in the optical path between said diffusing optical element and said light source.

71. The lighting system of claim 70, wherein the light source is configured to produce at least about 10,000 nits in said beam pattern produced by said projection optics.

72. The lighting system of claim 71, wherein said mask has an optical aperture therein.

73. The lighting system of claim 70, wherein said optical aperture is about the size of an intermediate focus between said light source and said projection lens where said light is substantially concentrated.

74. The lighting system of claim 71, wherein said optical aperture is substantially circular.

75. The lighting system of claim 74, wherein said optical aperture is about the size of an intermediate focus between said light source and said projection lens where said light is substantially concentrated.

76. The lighting system of claim 71, further comprising a collector, said mask being disposed between said collector and the diffuser.

77. The lighting system of claim 76, wherein said mask is proximal to a front face of said collector.

78. The lighting system of claim 76, wherein the mask is disposed at the focus of the collector and the aperture is centered about the optical axis.

79. The lighting system of claim 70, further comprising a flashlight housing for forming a flashlight.

80. The lighting system of claim 70, further comprising a track lighting connector for connection with a track for track lighting.

81. The lighting system of claim 70, further comprising a bike light housing, an automobile light housing, an architectural light housing, a display case light housing, a surgical light housing, a stage light housing, or a studio light housing.

82. The lighting system of claim 70, wherein said light source, said diffusing optical element and said projection optics are integrated together into a solid state emitter module.

83. A lighting system for providing lighting, said lighting system configured to produce a beam pattern, said lighting system comprising:
a light source;
a diffusing optical element;
projection optics, said projection optics configured to project a beam having said beam pattern, said diffusing optical element disposed in an optical path between said light source and said projection optics,
wherein the projection optics is diffusing.

84. The lighting system of claim 83, wherein the light source is configured to produce at least about 10,000 nits in said beam pattern produced by said projection optics.

85. The lighting system of claim 83, wherein the projection optics comprises a surface that is faceted.

86. The lighting system of claim 83, wherein the projection optics comprises a textured surface.

87. The lighting system of claim 83, wherein the projection optics comprises diffusing volume features.

88. The lighting system of claim 83, wherein the projection optics comprises an aspheric surface.

89. The lighting system of claim 88, wherein said aspheric surface comprises an ellipsoidal surface.

90. The lighting system of claim 83, further comprising a flashlight housing for forming a flashlight.

91. The lighting system of claim 83, further comprising a track lighting connector for connection with a track for track lighting.

92. The lighting system of claim 83, further comprising a bike light housing, an automobile light housing, an architectural light housing, a display case light housing, a surgical light housing, a stage light housing, or a studio light housing.

93. The lighting system of claim 83, wherein said light source, said diffusing optical element and said projection optics are integrated together into a solid state emitter module.

94. A lighting system for providing lighting, said lighting system configured to produce a beam pattern, said lighting system comprising:
a light source;
a first diffusing optical element;
projection optics, said projection optics configured to project a beam having said beam pattern, said first diffusing optical element disposed in an optical path between said light source and said projection optics; and
a second diffusing optical element, said projection optics between said first and second diffusing optical elements.

95. The lighting system of claim 94, wherein the light source is configured to produce at least about 10,000 nits in said beam pattern produced by said projection optics.

96. The lighting system of claim 95, wherein said second diffusing optical element comprises a diffuser forward of said projection lens.

97. The lighting system of claim 95, further comprising a collector disposed with respect to said light source to substantially concentrate light at a focus, said first diffusing optical element disposed away from said focus.

98. The lighting system of claim 94, wherein said second diffusing optical element is an asymmetric optical element that produces an asymmetric beam pattern.

99. The lighting system of claim 94, further comprising a flashlight housing for forming a flashlight.

100. The lighting system of claim 94, further comprising a track lighting connector for connection with a track for track lighting.

101. The lighting system of claim 94, further comprising a bike light housing, an automobile light housing, an architectural light housing, a display case light housing, a surgical light housing, a stage light housing, or a studio light housing.

102. The lighting system of claim 94, wherein said light source, said diffusing optical element, and said projection optics are integrated together into a solid state emitter module.

103. An lighting system for providing lighting, said lighting system configured to produce a variable beam pattern, said lighting system comprising:
a light source;
projection optics, said projection optics configured to project a beam having said beam pattern, said light source and said projection optics forming an optical path; and
a variable diffusing optical element disposed in said optical path, said variable diffusing optical element configured to distribute light into a range of directions defined by an angular spread, said variable diffusing optical element adjustable to vary said angular spread to alter said beam pattern.

104. The lighting system of claim 103, wherein the light source is configured to produce at least about 10,000 nits in said beam pattern produced by said projection optics.

105. The lighting system of claim 103, wherein said diffusing optical element comprises a diffuser.

106. The lighting system of claim 105, wherein said diffuser comprises electro-optic or magneto-optic material.

107. The lighting system of claim 106, wherein said diffuser comprises electrodes disposed with respect to each other to applying an electric field to said electro-optic material to switch said diffuser.

108. The lighting system of claim 105, wherein said diffuser comprises polymer dispersed liquid crystal.

109. The lighting system of claim 103, wherein said diffusing optical element is fixed along said optical axis with respect to said light source and said projection optics.

110. The lighting system of claim 103, further comprising a flashlight housing for forming a flashlight.

111. The lighting system of claim 103, further comprising a track lighting connector for connection with a track for track lighting.

112. The lighting system of claim 103, further comprising a bike light housing, an automobile light housing, an architectural light housing, a display case light housing, a surgical light housing, a stage light housing, or a studio light housing.

113. The lighting system of claim 103, wherein said light source, said diffusing optical element and said projection optics are integrated together into a solid state emitter module.
